(19) United States
(12) Patent Application Publication
(10) Pub. No.: US 2026/0333434 A1
(43) Pub. Date: Oct. 22, 2026

(54) Systems and Methods for Dynamic Non-Primary Channel Access Management

(71) Applicant: Cisco Technology, Inc., San Jose, CA (US)

(72) Inventors: Domenico Ficara, Essertines-sur-Yverdon (CH); Brian Hart, Los Altos Hills, CA (US); Binita Gupta, San Diego, CA (US); Sachin D. Wakudkar, St-Sulpice (CH); Ugo Campiglio, Ecublens (CH)

(21) Appl. No.: 19/647,636

(22) Filed: Apr. 14, 2026

Related U.S. Application Data
(60) Provisional application No. 63/790,415, filed on Apr. 17, 2025.
(60) Provisional application No. 63/790,608, filed on Apr. 17, 2025.

(51) Int. Cl. H04W 74/0816

(52) U.S. Cl. CPC H04W 74/0816

(57) ABSTRACT

Systems and methods for dynamic non-primary channel access management in wireless networks. An access point may receive a restricted target wake time schedule indicating an anticipated useful transmission from a neighboring network. To reduce localized overlapping basic service set interference, the access point can poll connected stations to evaluate their specific hardware capabilities and physical environments. Subsequently, the access point may receive preferred channel feedback from a station. Utilizing this individualized feedback, the access point can determine an optimal non-primary channel tailored to the station. The access point may then transmit an instruction to the station to switch channels and route regular traffic via the optimal non-primary channel. This proactive routing strategy can preserve the primary channel for low-latency traffic, progressively increasing overall network throughput while substantially reducing packet collisions without typically necessitating broad frequency changes for all devices.

### PRIORITY

This application claims the benefit and priority to these applications, U.S. Provisional Application No. 63/790,415, filed Apr. 17, 2025 and U.S. Provisional Application No. 63/790,608, filed Apr. 17, 2025, the entire contents of both of which are incorporated by reference herein.

### FIELD

The present disclosure relates to dynamic non-primary channel access management. More particularly, the present disclosure relates to proactively scheduling non-primary channel access and optimizing non-primary channel assignments on a per-station basis.

### BACKGROUND

Wireless local area networks have become ubiquitous in both residential and enterprise environments. The proliferation of connected devices, ranging from smartphones and laptops to smart home appliances and industrial sensors, has driven a continuous demand for higher data throughput and lower latency. To accommodate these demands, wireless standards have continually evolved to support wider channel bandwidths, more complex modulation schemes, and increased overall network capacity.

As the density of wireless deployments increases, multiple independent networks frequently operate in close physical proximity. This high density often results in overlapping basic service sets, where transmissions from one access point or connected device can interfere with the communications of a neighboring network. Such interference is particularly problematic in environments like apartment buildings, office complexes, or public venues, where the available radio frequency spectrum becomes highly congested.

Traditionally, network devices rely on carrier sense and collision avoidance mechanisms to navigate these congested spectrums. Devices will typically monitor a designated primary operating channel and wait for it to clear before initiating a transmission. As modern networks transition to utilizing significantly wider bandwidths, a single interfering transmission on a narrow portion of the shared spectrum can potentially render an entire wideband channel unusable for a duration of time. Managing traffic efficiently in these increasingly crowded and complex wireless environments remains a significant challenge for network administrators and equipment manufacturers.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic diagram of a wireless environment in accordance with various embodiments of the disclosure;

FIG. 2 is a schematic diagram of Open Systems Interconnection (OSI) layers in accordance with various embodiments of the disclosure;

FIG. 3 is a diagram of an overlapping basic service set (OBSS) interference environment in accordance with various embodiments of the disclosure;

FIG. 4 is a block diagram of a multi-channel assignment topology in accordance with various embodiments of the disclosure;

FIG. 5 is a sequence diagram of non-primary channel access feedback and scheduling in accordance with various embodiments of the disclosure;

FIG. 6 is a schematic diagram of a deployment environment in accordance with various embodiments of the disclosure;

FIG. 7 is a flowchart showing a process for an access point method in accordance with various embodiments of the disclosure;

FIG. 8 is a flowchart showing a process for a station method in accordance with various embodiments of the disclosure;

FIG. 9 is a flowchart showing a complex channel reassignment process in accordance with various embodiments of the disclosure;

FIG. 10 is a flowchart showing a multi-link operation cross-link non-primary channel access process in accordance with various embodiments of the disclosure;

FIG. 11 is a flowchart showing a same-BSS low latency scheduling process in accordance with various embodiments of the disclosure;

FIG. 12 is a flowchart showing an out of band multi-AP coordination process in accordance with various embodiments of the disclosure; and

FIG. 13 is a conceptual block diagram for one or more devices capable of executing components and logic for implementing the functionality and embodiments described above.

Corresponding reference characters indicate corresponding components throughout the several figures of the drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. In addition, common, but well-understood, elements that are useful or necessary in a commercially feasible embodiment are often not depicted to facilitate a less obstructed view of these various embodiments of the present disclosure.

### DESCRIPTION OF EXAMPLE EMBODIMENTS

### Overview

In some embodiments, a network device includes a processor, at least one network interface controller configured to provide access to a network, and a memory communicatively coupled to the processor, wherein the memory includes a dynamic NPCA management logic. The logic is configured to measure local overlapping basic service set interference, compute a preferred non-primary channel based on at least the measured interference, transmit the computed preference to an access point, receive an instruction to switch to an assigned non-primary channel, and switch to the assigned non-primary channel

In some embodiments, a method of non-primary channel access includes receiving a restricted target wake time schedule, receiving a preferred channel feedback from a station, determining an optimal non-primary channel for the station, transmitting an instruction to the station, and routing traffic to the station via the optimal non-primary channel.

### EXAMPLE EMBODIMENTS

Wireless local area networks have become ubiquitous in both residential and enterprise environments. The proliferation of connected devices has driven a demand for higher data throughput and lower latency. As the density of wireless deployments increases, multiple independent networks frequently operate in close physical proximity. This high density often results in overlapping basic service set interference, where transmissions from one network can disrupt the communications of a neighboring network. Traditional carrier sense and collision avoidance mechanisms may struggle to manage traffic efficiently in these congested spectrums, typically necessitating advanced coordination to reduce packet loss and maintain appropriate throughput.

To address these challenges, the embodiments described herein can provide systems and methods for dynamic non primary channel access management. Rather than relying on standard collision avoidance, network coordinators could proactively schedule data transmissions to avoid anticipated interference. By gathering localized environmental data from individual client devices, the network infrastructure might formulate a highly targeted routing strategy. This proactive approach may allow administrators to seamlessly detour standard traffic away from congested frequencies. Consequently, the overall wireless environment could experience progressively increased capacity without disrupting active user sessions.

A primary aspect of the embodiments described herein might involve establishing a robust feedback loop between the access points and the connected stations. Because interference patterns can vary wildly across a physical space, a single routing decision might not be appropriate for every device. To solve this, individual endpoints may compute preferred non primary channel recommendations based on their own localized measurements and hardware capabilities. These endpoints could then transmit their customized feedback to the network coordinator. By processing this individualized intelligence, the infrastructure might assign specific detour pathways tailored to the unique constraints of each client, thereby substantially reducing the likelihood of communication drops.

Furthermore, the embodiments described herein can dynamically separate different traffic types to ensure that appropriate timing constraints are satisfied. Modern networks often handle a mix of standard background downloads and highly sensitive low latency streams, such as voice over internet protocol calls. To accommodate these diverse needs, an access point might schedule latency sensitive devices on a reserved, reduced bandwidth primary channel. Concurrently, the access point may instruct other connected devices to move their standard traffic to assigned non primary channels. This coordinated detour strategy can keep the primary frequency clear of congestion, allowing useful transmissions to proceed with minimal delay.

In addition to single link optimizations, the dynamic non primary channel access management techniques could leverage multi-link operations and out of band coordination. Devices capable of maintaining multiple simultaneous connections might receive instructions to shift their traffic to an idle link if their default pathway experiences overlapping basic service set interference. Moreover, neighboring access points may communicate their upcoming useful transmission schedules over wired backhaul connections. This advanced warning could allow the local routers to preemptively transition their stations to detour frequencies before a primary channel conflict occurs. Ultimately, these integrated methodologies might offer a robust framework for managing dense wireless deployments and optimizing the user experience.

Often a basic service set can be understood as the foundational building block of a standard wireless network infrastructure. A basic service set might typically comprise a single access point and the various client stations that are currently connected to it. Within this designated coverage area, all devices may share the same radio frequency medium to exchange data packets. Because the available spectrum is a shared resource, managing the airtime among these local devices typically necessitates proactive scheduling to reduce internal collisions. Furthermore, a cohesive enterprise network could link several of these foundational blocks together to create a broader mobility domain for users.

Those skilled in the art will recognize that an overlapping basic service set may occur when multiple independent networks are deployed in close physical proximity. When the coverage areas intersect, transmissions from one network might bleed over and cause interference on the shared frequencies utilized by a neighboring network. This external congestion could substantially reduce the reliability of connections and progressively degrade overall data throughput. To navigate this interference, network coordinators may monitor the environmental conditions and proactively assign devices to alternative frequencies. By understanding the boundaries and impact of an overlapping basic service set, administrators can implement routing strategies that maintain persistent connectivity for all users.

In various embodiments, a multi-link operation can represent an advanced networking capability that allows a device to establish and maintain multiple concurrent wireless connections. Rather than being restricted to a single frequency band, a multi-link capable device might simultaneously communicate across two point four gigahertz, five gigahertz, and six gigahertz spectrums. This versatile hardware configuration may provide the network infrastructure with several alternative pathways to route data payloads. Furthermore, the ability to utilize multiple links could ensure that a mobile endpoint retains a persistent connection even if one specific frequency experiences sudden radio frequency interference.

Those skilled in the art will appreciate that the implementation of a multi-link operation might allow a network to progressively increase its overall data throughput by aggregating bandwidth across diverse channels. If a primary operating frequency becomes congested due to an overlapping basic service set, the routing logic could seamlessly detour standard traffic to an idle secondary link. This proactive transition may occur without typically necessitating a disruptive disconnection and reconnection sequence for the client device. Additionally, leveraging these concurrent connections can help the system satisfy appropriate latency requirements for sensitive applications by dedicating a clear pathway specifically for prioritized traffic.

Often a target wake time schedule can function as a proactive power management and traffic coordination protocol. A target wake time agreement might allow an access point to negotiate specific, predictable time windows during which a connected station will wake up to send or receive data. Outside of these designated windows, the client device may place its radio transceivers into a low power sleep state to conserve battery life. This scheduled approach could substantially reduce the instances of multiple devices attempting to access the wireless medium simultaneously. Consequently, utilizing a target wake time protocol might help clear the channel of random, unpredictable background traffic.

In numerous embodiments, a restricted target wake time schedule may represent an even more appropriate allocation of network resources tailored for high priority data streams. A restricted target wake time might ensure that a specific portion of the spectrum is reserved primarily for a designated device executing a latency sensitive application. By evaluating these restricted schedules, an access point could anticipate upcoming useful transmissions and proactively detour standard traffic away from the reserved frequency. This predictive routing strategy may ensure that time sensitive packets are delivered with reduced delay, without typically necessitating the degradation of other active network sessions.

In various embodiments, non-primary channel access can be understood as the process of routing specific network traffic away from a default operating frequency. In many standard configurations, an access point and its connected stations might default to exchanging management frames and data on a single primary channel. However, when this primary link experiences heavy loads or external interference, relying on a single pathway could substantially reduce overall performance. Non primary channel access may enable the infrastructure to assign secondary, alternative frequencies to specific devices based on their individual traffic needs and hardware capabilities. This targeted detouring could progressively increase the capacity of the wireless environment.

Those skilled in the art will recognize that executing non primary channel access typically necessitates a robust feedback loop between the infrastructure and the client endpoints. To select an optimal detour, a router might prompt a connected station to measure its localized interference and compute a preferred secondary channel. Upon receiving this customized recommendation, the network coordinator may issue a specific instruction commanding the device to switch its radio hardware to the newly assigned frequency. By moving standard background data to these alternative pathways, the system could keep the primary channel clear for applications that have appropriate timing constraints, ensuring persistent and reliable communication across the network.

The embodiments described herein may address the need to manage complex wireless interference caused by overlapping networks, which can disrupt a critical transmission. To solve these congestion issues, a network device can feature a memory communicatively coupled to a processor to execute dynamic routing. The routing decisions might be derived from an unsolicited beacon report sent by a station. This unsolicited feedback can provide interference metrics derived from the proximity of the station to overlapping networks. By reassigning standard traffic to a non-primary channel, the system preserves the primary channel for a critical low-latency data stream. This detouring preserves overall bandwidth and preserves connection stability, enabling more than one non-primary channel for access if the feedback indicates at least two non-overlapping preferred non-primary channels.

In further embodiments, the logic communicatively coupled to the processor could utilize advanced scheduling to handle another critical scheduled operation. For instance, the system may set an intra-basic service set network allocation vector for a second station, directing the station to utilize the optimal non-primary channel for a duration of the intra-basic service set network allocation vector. The duration of this vector might be derived from an estimated power requirement, which itself could be derived from the physical proximity of the device. Additionally, a controller communicatively coupled to the access point can transmit a multi-user enhanced distributed channel access parameter set comprising an active timer. The instruction might direct the station to utilize the optimal non-primary channel while the active timer is running. This multi-user enhanced parameter set may help coordinate multiple devices if a third non-overlapping channel and a fourth non-overlapping channel are typically necessitated to avoid a critical interference event. How long the timer remains running can be derived from further unsolicited feedback or derived from other multi-user metrics. While the active timer is running, the network can leverage a multi-user enhanced framework and a final non-overlapping frequency to secure a critical connection, thereby ensuring that even the most critical transmissions reach their destination based on the proximity of the receiving endpoint without intra-basic collisions.

Aspects of the present disclosure may be embodied as an apparatus, a system, a method, or a computer program product. Accordingly, aspects of the present disclosure may take the form of an entirely hardware embodiment, inserted into a prior deployment, an entirely software embodiment (including firmware, resident software, micro-code, or the like), or an embodiment combining software and hardware aspects that may all generally be referred to herein as a “function,” a “module,” an “apparatus,” or a “system.” Furthermore, aspects of the present disclosure may take the form of a computer program product embodied in one or more non-transitory computer-readable storage media storing computer-readable and/or executable program code. Many of the functional units described in this specification have been labeled as functions, to emphasize their implementation independence more particularly. For example, a function may be implemented as a hardware circuit comprising custom Very Large Scale Integration (VLSI) circuits, Application Specific Integrated Circuits (ASICs), or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, a procedure, or a function. The executables of an identified function need not be physically located together but may comprise disparate instructions stored in different locations which, when joined logically together, comprise the function and achieve the stated purpose for the function.

Some portions of the embodiments described herein may be presented in terms of algorithms and symbolic representations of operations on data bits within a computer memory. These algorithmic descriptions and representations are commonly utilized by those skilled in the data processing arts to convey the substance of their work to others skilled in the art. An algorithm is generally understood to be a self-consistent sequence of steps leading to a desired result. These steps typically involve physical manipulations of physical quantities. Furthermore, an algorithm may be implemented with lines of code in software, configured logic gates in hardware, or a combination of both. In various embodiments, the logic can comprise electronic circuits that follow the rules of Boolean logic, software that contains patterns of instructions, or any combination thereof.

Likewise, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, an apparatus, a processor, or a device.

Computer program code for carrying out operations for aspects of the present disclosure may be written in any combination of one or more programming languages, including an object-oriented programming language such as Python, Java, C++, C#, Objective-C, Go, Rust, Swift, or the like, conventional procedural programming languages, such as the “C” programming language, scripting programming languages, and/or other similar programming languages. The program code may execute partly or entirely on one or more of a user’s computer and/or on a remote computer or server over a data network or the like.

Furthermore, any data structures, databases, tables, lists, or other data organizations described herein outside of the claims are intended to be conceptual representations rather than structural limitations. It is contemplated that the data described could be organized, stored, and managed using a wide variety of software architectures, including relational databases, non-relational databases, flat files, linked lists, trees, arrays, or object-oriented structures, without departing from the scope of the present disclosure. Accordingly, any specific references to fields, indices, or pointers within such data structures are provided merely for illustrative purposes and may be substituted with equivalent data tracking mechanisms.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages, or the like) or other discrete electrical devices, in electrical communication with one or more other components through electrical lines of a Printed Circuit Board (PCB) or the like. Each of the functions and/or modules described herein, in numerous additional embodiments, may alternatively be embodied by or implemented as a component.

A circuit, as used herein, comprises a set of one or more electrical and/or electronic components providing one or more pathways for electric current. In still yet further embodiments, a circuit may include a return pathway for electric current, so that the circuit is a closed loop. In still yet additional embodiments, however, a set of components that does not include a return pathway for electric current may be referred to as a circuit (e.g., an open loop). For example, an integrated circuit may be referred to as a circuit regardless of whether the integrated circuit is coupled to ground as a return pathway for electric current or not. In several embodiments, a circuit may include a portion of an integrated circuit, an integrated circuit, a set of integrated circuits, a set of non-integrated electrical and/or electrical components with or without integrated circuit devices, or the like. In several more embodiments, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, a programmable array logic, a programmable logic device, or the like (e.g., as firmware, a netlist, or the like). A circuit may comprise one or more silicon integrated circuit devices (e.g., chips, die, die planes, packages, or the like) or other discrete electrical devices, in electrical communication with one or more other components through electrical lines of a PCB or the like. Each of the functions and/or modules described herein, in various embodiments, may be embodied by or implemented as a circuit.

Furthermore, while various embodiments described herein may incorporate artificial intelligence or machine learning components, it is contemplated that such models are optional and not strictly required unless explicitly recited in the claims. To the extent artificial intelligence or machine learning is implemented, these models are configured to solve specific technical problems and improve the functioning of the underlying computing systems, rather than merely applying generic algorithms to a new technological environment. Specifically, the customized logic, training methodologies, and data pipelines described herein are intended to structurally improve the algorithms themselves to, for example, increase operational efficiency and/or reduce required computational resources. Moreover, the outputs generated by these models are inherently tied to automated, downstream physical actions or system state changes, such as triggering remedial actions or modifying network operations, rather than merely outputting abstract informational data for human consumption.

It should be explicitly understood that the embodiments described herein are not intended to be interpreted under 35 U.S.C. § 112(f) unless the exact phrase “means for” or “step for” is explicitly recited. The use of terms such as “component,” “module,” “logic,” “circuit,” “system,” or “controller” in the claims or specification is intended to denote structural hardware and/or software implementations and should not be construed as invoking means-plus-function or step-plus-function embodiments. Furthermore, such terms are not intended to be nonce words or generic placeholders. Rather, to a person of ordinary skill in the art, these terms connote and correspond to adequate physical structure, specific executable algorithms, and tangible component interactions for performing the operations described herein.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, references to reading, writing, storing, buffering, and/or transferring data can include the entirety of the data, a portion of the data, a set of the data, and/or a subset of the data. Furthermore, the term data is intended to broadly encompass user payloads, control signals, metadata, or any other digital representations of information. Operations performed on this data may involve logical abstractions, physical memory transformations, or both, depending on the specific hardware or software implementation.

Lastly, the terms “or” and “and/or” as used herein are to be interpreted as inclusive or meaning any one or any combination. Therefore, “A, B, or C” or “A, B, and/or C” mean “any of the following: A; B; C; A and B; A and C; B and C; A, B, and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

Moreover, while certain embodiments may describe functions executing on a specific device or processor, it should be understood that the disclosed systems and methods are highly scalable and may be implemented in distributed computing environments. The functions, modules, and processes described herein may be deployed across a plurality of network-connected systems, including cloud computing platforms, Infrastructure as a Service (IaaS) environments, virtualized servers, containers, or microservices architectures. In such distributed systems, operations may be performed collaboratively by multiple computing nodes communicating over a local area network (LAN), a wide area network (WAN), or the public Internet.

Likewise, references to “memory,” “storage media,” or “storage devices” are intended to encompass a broad array of tangible, non-transitory computer-readable media. While specific examples such as random-access memory (RAM) or NAND flash memory may be discussed, the concepts disclosed herein are equally applicable to other forms of volatile and non-volatile memory technologies. These include, but are not limited to, phase-change memory (PCM), magnetoresistive RAM (MRAM), resistive RAM (ReRAM), 3D XPoint, solid-state drives (SSDs), magnetic storage, optical storage, or any future combinations of electrical, magnetic, optical, or chemical memory technologies capable of persisting digital information.

Unless specifically stated otherwise, it is appreciated that throughout the embodiments described herein discussions utilizing terms such as “processing,” “computing,” “calculating,” “determining,” “displaying,” or the like, refer to the actions and processes of a computer system, or similar electronic computing device. These actions and processes manipulate and transform data represented as physical (electronic) quantities within the computer system’s registers and memories into other data similarly represented as physical quantities within the computer system memories or registers, or other such information storage, transmission, or display devices.

Furthermore, where a component, module, or logic is described as cooperating, interfacing, or communicating with another component, module, or logic, it should be understood that such interaction inherently connotes the presence of structural interfaces, communication protocols, and/or Application Programming Interfaces (APIs) configured to facilitate the described interaction. Therefore, descriptions of interactions between modules should be interpreted as recitations of structural relationships rather than purely functional outcomes. As such, these inter-component communications represent tangible data pathways that dictate the physical exchange of electronic signals, memory allocations, or executable instructions between the respective structural elements.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

Additionally, within the various flowchart diagrams described herein, certain blocks, steps, or operations may be denoted as “optional.” The designation of a particular block as optional is not intended to imply that the remaining blocks are strictly required or non-optional. Instead, the depiction of optional blocks serves as a structural shorthand to conceptualize that multiple distinct variations of a process are possible. In this manner, a single flowchart depicting one or more optional blocks should be understood to represent and disclose multiple separate flowcharts corresponding to every combination and permutation of the included and omitted optional steps. Therefore, all such variations of the processes, whether incorporating or excluding the designated optional blocks, are to be considered fully integrated and incorporated into the present specification.

Finally, it is contemplated that any of the processes or flowcharts described herein may be implemented with fewer blocks than explicitly illustrated. For example, an embodiment depicting a process with four blocks may alternatively be practiced utilizing only three of those blocks, or only two of those blocks, and so on. Moreover, the specific blocks described may be performed in alternative sequences or in a different order than depicted, as may be appropriate based on the requirements of a desired application.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

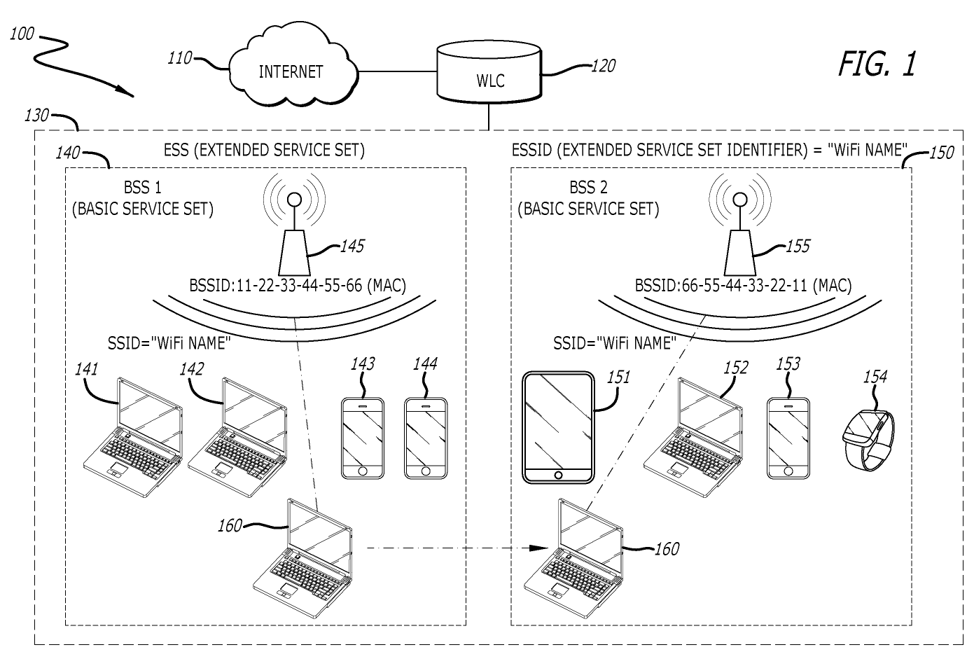

Referring to FIG. 1, a schematic diagram of a wireless environment in accordance with various embodiments of the disclosure is shown. In various embodiments, a network environment 100 can facilitate wireless communication among a plurality of connected devices. The network environment 100 may represent an enterprise deployment where extensive wireless coverage might be typically necessitated to accommodate numerous mobile users. Within the network environment 100, dynamic non-primary channel access management techniques might be implemented to allow devices to transition smoothly between channels without additional service interruptions. Furthermore, the network environment 100 could incorporate sophisticated protocols to handle resource management tasks associated with overlapping basic service set interference.

In some embodiments, the network environment 100 can be communicatively coupled to an internet 110. The internet 110 might serve as a broad wide area network infrastructure that can route traffic to and from external servers or services. Access to the internet 110 may be essential for the various client devices that might seek to download data, stream media, or communicate with remote applications. Additionally, the internet 110 could provide the necessary backhaul connectivity typically necessitated to support the extensive data demands of a modern enterprise wireless setup.

In certain embodiments, a wireless controller 120 can be deployed to manage and coordinate multiple access points within the network environment 100. The wireless controller 120 may orchestrate network-wide policies, handle authentication processes, and monitor the overall health of the wireless network infrastructure. Furthermore, the wireless controller 120 could assist in managing out-of-band multi-AP coordination, allowing access points to share scheduled useful transmissions. By centralizing these control functions, the wireless controller 120 might reduce the administrative overhead typically necessitated to maintain persistent connectivity and mitigate interference.

In many embodiments, an extended service set 130 can define a larger cohesive wireless coverage area created by linking multiple basic service sets. The extended service set 130 may act similarly to a mobility domain, wherein a client device might associate once and then roam freely among the constituent access points without typically necessitating the device to re-associate or re-authenticate. Operating within the extended service set 130 could reduce interference by allowing coordinated restricted target wake time schedules between nodes. Consequently, the extended service set 130 might provide a unified network presence, often identified by a single network name or identifier across a wide physical area.

In further embodiments, a first basic service set 140 can represent a foundational building block of the wireless network. The first basic service set 140 might encompass the specific physical coverage area provided by a single wireless access node. Devices located within the first basic service set 140 can communicate through a shared wireless medium managed by that central node. The first basic service set 140 may also handle local resource allocation, primary channel assignments, and predictive scheduling of non-primary channels for the devices currently connected within its boundaries.

In additional embodiments, a first laptop 141 can be positioned within the boundaries of the first basic service set 140. The first laptop 141 may function as a non-access point multi-link device capable of establishing sophisticated wireless connections. To maintain optimal performance, the first laptop 141 might persistently measure local overlapping basic service set interference associated with its current connection. Additionally, the first laptop 141 could transmit preferred channel feedback to the network to facilitate per-station optimized non-primary channel assignments.

In some embodiments, a second laptop 142 can also operate within the first basic service set 140. The second laptop 142 might share the wireless medium with other devices, typically necessitating efficient airtime management by the network infrastructure. Like other client devices, the second laptop 142 could leverage advanced wireless standards to execute high-throughput data transmissions. Furthermore, the second laptop 142 may be configured to interpret specialized signaling frames, such as initial control frames, that instruct it to switch to an assigned non-primary channel.

In certain embodiments, a first smartphone 143 can be connected to the network within the first basic service set 140. The first smartphone 143 might represent a highly mobile device that frequently encounters varying interference environments as a user carries it through a building. To preserve battery life and ensure smooth application performance, the first smartphone 143 could compute a preferred non-primary channel based on its specific hardware capabilities, such as its channel switching delays. The first smartphone 143 may rely on proactive scheduling protocols to keep its active audio or video sessions uninterrupted.

In many embodiments, a second smartphone 144 can be similarly situated within the first basic service set 140. The second smartphone 144 might generate varying levels of regular network traffic depending on the specific applications being actively utilized by a user. As network congestion fluctuates, the second smartphone 144 could receive instructions to utilize a non-primary channel. By adhering to these instructions, the second smartphone 144 may help the network optimize resource reservations, clear the primary channel for other traffic, and reduce overall capacity degradation.

In various embodiments, a first access point 145 can serve as the central coordinating node for the first basic service set 140. The first access point 145 may broadcast a specific network identifier and a unique hardware address to facilitate device connections. As an access point multi-link device, the first access point 145 could manage multiple concurrent communication links with its associated clients. Moreover, the first access point 145 might execute dynamic NPCA management logic to receive preferred channel feedback, determine optimal non-primary channels for individual stations, and transmit channel switch instructions.

In some embodiments, a second basic service set 150 can provide an adjacent or overlapping area of wireless coverage. The second basic service set 150 might share the same extended service set identifier as the first basic service set 140 to promote a unified user experience. Transmissions within the second basic service set 150 can create overlapping basic service set interference for devices in neighboring areas. The second basic service set 150 may also evaluate its own current load to determine scheduling for its connected devices.

In further embodiments, a tablet 151 can be actively communicating within the second basic service set 150. The tablet 151 might consume additional network bandwidth if streaming high-definition media or participating in video conferences. To manage such demands, the network infrastructure could instruct the tablet 151 to move its regular traffic to a secondary channel. The tablet 151 may parse management frames, such as beacons comprising new information elements, to discover scheduled non-primary channel access windows.

In additional embodiments, a third laptop 152 can be connected to the infrastructure via the second basic service set 150. The third laptop 152 could utilize multi-link operation features to maintain multiple links during its operational session. If the third laptop 152 were to detect a busy onboarding link, it might identify an idle link from its multiple links. The third laptop 152 may then receive instructions to perform non-primary channel access on the selected idle link to reduce dropped connections.

In numerous embodiments, a third smartphone 153 can be located in the second basic service set 150. The third smartphone 153 might represent a device with appropriate latency requirements for voice-over-IP applications. To satisfy these requirements, the third smartphone 153 could benefit from same-BSS low latency scheduling. The network might schedule the third smartphone 153 on a reduced-bandwidth primary channel while moving regular traffic from other devices to non-primary channels.

In some embodiments, a smartwatch 154 can also operate within the second basic service set 150. The smartwatch 154 may have limited processing power and battery capacity compared to larger computing devices. Consequently, the smartwatch 154 might heavily rely on the network infrastructure to optimize its connection and reduce the overhead associated with channel switching. By participating in a per-station optimized system, the smartwatch 154 could receive a customized secondary channel assignment that accounts for its power constraints as a user moves about the environment.

In certain embodiments, a second access point 155 can anchor the communications for the second basic service set 150. The second access point 155 may act as a source of restricted target wake time schedules. When preparing for a useful transmission, the second access point 155 could reserve specific resources and determine an appropriate execution window based on its own resource availability. Furthermore, the second access point 155 might transmit this dynamically determined schedule to other access points to facilitate predictive traffic management.

In various embodiments, a roaming laptop 160 can physically transition between different physical locations within the overall infrastructure. The roaming laptop 160 might experience varying levels of overlapping basic service set interference as it moves. Following these changes in the radio frequency environment, the roaming laptop 160 could update its preferred non-primary channel computations. The roaming laptop 160 may carefully monitor its local channel quality to ensure its feedback accurately reflects its current physical location before the access point assigns a secondary channel.

In a non-limiting example, the components of the network environment 100 can interact to facilitate a proactive channel switch for a mobile user. The first access point 145 might receive a scheduled useful transmission plan from the second access point 155 via the wireless controller 120 over an out-of-band wired connection. To ensure persistent service and reduce interference, the first access point 145 could identify a primary channel conflict. The first access point 145 may then determine an optimal non-primary channel for the first laptop 141 based on previously received feedback. Subsequently, the first access point 145 might execute a channel switch instruction, directing the first laptop 141 to the assigned secondary channel before the scheduled interference occurs, thereby avoiding any disruption in connectivity.

For instance, the network environment 100 may dynamically adapt to changing traffic conditions to optimize overall efficiency. If the first access point 145 receives low-latency traffic for the first smartphone 143, it might need to conserve its available resources on the primary channel. The first access point 145 could schedule the first smartphone 143 on a reduced bandwidth primary channel. Concurrently, the first access point 145 may instruct the second smartphone 144 and the second laptop 142 to utilize non-primary channels. This proactive routing may force the regular traffic onto secondary channels, ensuring the first access point 145 does not hold up low-latency packets during peak usage. By tailoring the detour for each device based on their individual capabilities, the system might progressively increase overall network throughput.

It is contemplated that the wireless controller 120 can play a role in managing the broader multi-AP coordination within the extended service set 130. As the roaming laptop 160 transitions its physical location, its local interference profile might change. The first access point 145 and the second access point 155 could communicate over a backhaul network to securely exchange restricted target wake time schedules without typically necessitating the roaming laptop 160 to experience a collision. The dynamic NPCA management logic may oversee this process to ensure that the optimal non-primary channel is properly assigned so that data packets originating from the internet 110 are accurately routed to the roaming laptop 160 away from congested spectrums. This coordinated approach might drastically reduce overhead and ensure a high-quality user experience across the extended service set 130.

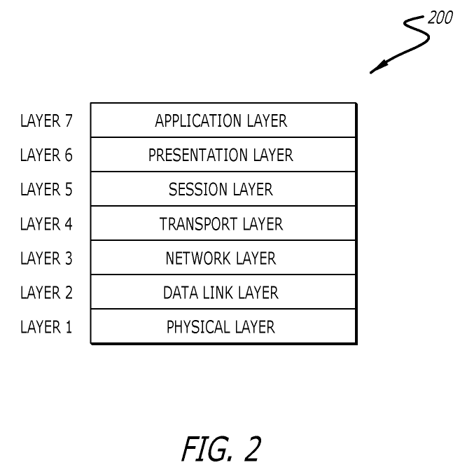

Although a specific embodiment for a network environment 100 for carrying out the various steps, processes, methods, and operations described herein is discussed with respect to FIG. 1, any of a variety of systems and/or devices may be utilized in accordance with embodiments of the disclosure. For example, the network environment 100 might encompass additional access points, different types of client devices, or operate over different wired and wireless protocols. The elements depicted in FIG. 1 may also be interchangeable with other elements of FIGS. 2–13 as required to realize a particularly desired embodiment.

Referring to FIG. 2, a diagram illustrating an Open Systems Interconnection (OSI) model in accordance with various embodiments of the disclosure is shown. In various embodiments, an OSI model 200 can provide a conceptual framework for understanding how different networking protocols interact to facilitate communication. The OSI model 200 might separate the complex processes of network communication into distinct, manageable functional layers. By utilizing the OSI model 200, network engineers and developers could troubleshoot issues by isolating problems to specific functional areas. Furthermore, the OSI model 200 may serve as a standard reference to ensure interoperability between diverse hardware and software systems across a wireless network environment managing non-primary channel access.

In many embodiments, an application layer (shown as layer 7) can represent the uppermost level of the OSI model 200 where network applications interact directly with software programs. The application layer might process user requests and provide services such as file transfers, email, and web browsing. When a client device initiates a preferred channel feedback computation, the application layer could be responsible for generating the initial data payload associated with that specific application's needs. Additionally, the application layer may interface with underlying communication sub-systems to ensure that data is correctly formatted before being passed down the stack.

In some embodiments, a presentation layer (shown as layer 6) can operate below the application layer to prepare data for transmission or consumption. The presentation layer might handle tasks such as data encryption, decryption, compression, and translation to ensure compatibility between different systems. During a dynamic channel switch event, the presentation layer could ensure that any secure context being transferred maintains its encrypted state. Moreover, the presentation layer may abstract the differences in data representation formats so that the application layer does not need to handle these complexities.

In further embodiments, a session layer (shown as layer 5) can establish, manage, and terminate connections between local and remote applications. The session layer might be useful for maintaining persistent dialogs or sessions as a mobile device transitions between a primary channel and an optimal non-primary channel. If a connection is temporarily disrupted during a channel switch execution phase, the session layer could facilitate the resumption of the session without typically necessitating the user to restart the application. Consequently, the session layer may coordinate communication synchronization points to ensure that data streams remain coherent and synchronized across the network.

In additional embodiments, a transport layer (shown as layer 4) can provide reliable or unreliable data transfer services depending on the specific requirements of the underlying application. The transport layer might utilize protocols to manage packet sequencing, error recovery, and flow control. As traffic is routed to the station via the optimal non-primary channel, the transport layer could be responsible for keeping sequence numbers aligned to reduce data loss. The transport layer may also segment large data messages into smaller packets suitable for transmission over the wireless medium.

In certain embodiments, a network layer (shown as layer 3) can manage the routing of data packets from a source device to a destination device across multiple interconnected networks. The network layer might assign logical addresses to ensure that packets reach their intended targets reliably. When a client device changes its operating channel during a proactively scheduled non-primary channel access, the network layer could interact with the distribution system mapping to update routing paths. Furthermore, the network layer may determine the optimal path for data packets based on current network loads and routing metrics.

In numerous embodiments, a data link layer (shown as layer 2) can provide node-to-node data transfer capabilities and handle error correction for physical transmission issues. The data link layer might manage hardware addresses, which are heavily utilized when a client device associates with a non-primary channel. During the channel switch preparation phase, the data link layer could be intimately involved in setting up new links and reserving necessary airtime resources. Additionally, the data link layer may process the specialized signaling frames that contain the restricted target wake time schedule.

In various embodiments, a physical layer (shown as layer 1) can represent the lowest level of the OSI model 200, responsible for the actual transmission and reception of raw bit streams over a physical medium. The physical layer might govern the radio frequency characteristics, modulation schemes, and antenna configurations used in wireless communications. When a device measures local overlapping basic service set interference to evaluate potential non-primary channels, those measurements could originate from the physical layer. Furthermore, the physical layer may execute the final step of wirelessly broadcasting the bits that comprise a channel switch instruction to a client device.

In a non-limiting example, the various layers of the OSI model 200 can collaborate to facilitate the dynamic non-primary channel access of a client device. When a smartphone initiates a video call, the application layer might capture the video data and pass it down the stack. The presentation layer could compress this video stream, while the session layer may establish a persistent communication dialog with a remote server. The transport layer might segment the video data, and the network layer could route these segments toward the current access point. As the smartphone prepares to switch channels, the data link layer may receive a management frame containing a specific channel switch instruction, which the physical layer physically captures from the wireless radio waves.

For instance, the OSI model 200 might dictate how data transmission is preserved during a network transition to reduce service disruption. As a laptop moves toward a new interference environment, the data link layer could negotiate a new link setup on a secondary channel and reserve necessary block acknowledgment resources. Concurrently, the transport layer may freeze its current sequence numbers to prepare for the channel switch. The network layer might update the distribution system mapping to reflect the laptop's new operating frequency. Through this coordinated effort across the data link layer, the network layer, and the transport layer, the overall transition could be executed efficiently before a scheduled useful transmission occurs on the primary channel.

It is contemplated that the OSI model 200 can provide a structural framework for implementing new network signaling mechanisms, such as a preferred non-primary channel feedback loop. A wireless controller could generate a restricted target wake time schedule at the application layer of its management software. This configuration data might be passed down through the transport layer and the network layer to reach a specific access point multi-link device. At the access point, the data link layer could encapsulate this schedule into a specific signaling frame, such as a beacon or initial control frame. Finally, the physical layer may broadcast the frame to all nearby client devices, allowing their respective communication stacks to parse the schedule and adjust their channel access behavior accordingly.

Although a specific embodiment for an OSI model 200 for carrying out the various steps, processes, methods, and operations described herein is discussed with respect to FIG. 2, any of a variety of systems and/or devices may be utilized in accordance with embodiments of the disclosure. For example, alternative networking models, such as a four-layer protocol suite, could be utilized to conceptualize and manage the network communications. The elements depicted in FIG. 2 may also be interchangeable with other elements of FIGS. 1 and 3–13 as required to realize a particularly desired embodiment.

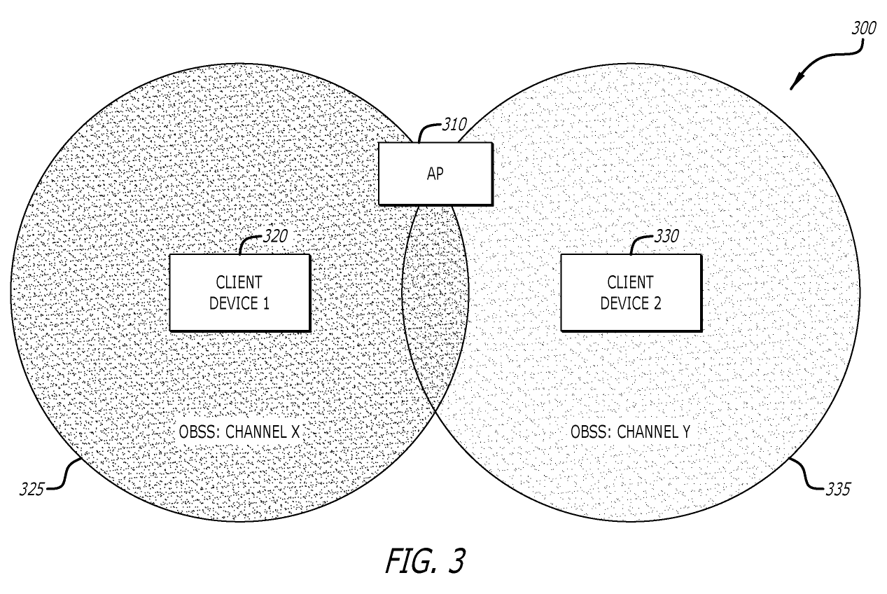

Referring to FIG. 3, a diagram of an overlapping basic service set interference environment in accordance with various embodiments of the disclosure is shown. In various embodiments, an overlapping basic service set interference environment 300 can represent a physical space where multiple wireless networks operate in close proximity. The overlapping basic service set interference environment 300 may experience varying levels of radio frequency congestion depending on the activity of nearby devices. By analyzing the overlapping basic service set interference environment 300, network administrators could implement dynamic non-primary channel access management techniques. Consequently, the overlapping basic service set interference environment 300 might serve as a foundational context for optimizing individual channel assignments to substantially reduce data loss.

In many embodiments, an access point 310 can be deployed within the overlapping basic service set interference environment 300 to manage wireless communications. The access point 310 might coordinate traffic for multiple connected devices by utilizing proactive scheduling algorithms. To reduce interference, the access point 310 could evaluate preferred channel feedback received from various stations. Furthermore, the access point 310 may transmit specific instructions directing devices to switch to optimal non-primary channels when the primary channel becomes congested.

In some embodiments, a first overlapping basic service set 325 can produce localized interference on a specific channel, such as channel X. The first overlapping basic service set 325 might emanate from a neighboring router that is not under the direct control of the access point 310. As devices move closer to the first overlapping basic service set 325, they may experience progressively degrading signal quality on the primary channel. Therefore, avoiding the first overlapping basic service set 325 could be useful for maintaining appropriate throughput for latency-sensitive applications.

In certain embodiments, a first client device 320 can operate within the coverage area affected by the first overlapping basic service set 325. The first client device 320 might measure the local radio frequency conditions to quantify the interference generated by the first overlapping basic service set 325. Upon computing these measurements, the first client device 320 could generate a preferred non-primary channel recommendation tailored to its specific physical location. The first client device 320 may then send this data back to the access point 310 to request a customized detour channel.

In further embodiments, a second overlapping basic service set 335 can create a separate zone of interference operating on a different frequency, such as channel Y. The second overlapping basic service set 335 might impact a completely different physical area within the overlapping basic service set interference environment 300. Because the second overlapping basic service set 335 operates independently, its traffic patterns could fluctuate differently than those of the first overlapping basic service set 325. Recognizing the distinct boundaries of the second overlapping basic service set 335 may allow the network to avoid a uniform channel assignment approach.

In additional embodiments, a second client device 330 can be physically located within the influence of the second overlapping basic service set 335. The second client device 330 might detect substantial interference on channel Y, which may not affect the first client device 320. Consequently, the second client device 330 could compute a completely different optimal secondary channel based on its unique environmental factors and hardware capabilities. The second client device 330 may communicate these distinct requirements to the access point 310 to ensure it receives an appropriate channel assignment.

For example, the components within the overlapping basic service set interference environment 300 can collaborate to provide per-station optimized non-primary channel access. The access point 310 might detect that a primary channel is scheduled to be busy and may prompt the connected devices for feedback. In response, the first client device 320 could report that the first overlapping basic service set 325 makes channel X unusable, while the second client device 330 might report that the second overlapping basic service set 335 makes channel Y unusable. The access point 310 may then process this diverse feedback to assign channel Y to the first client device 320 and channel X to the second client device 330, thereby navigating around the respective interference zones.

For instance, the overlapping basic service set interference environment 300 might experience rapidly changing conditions that typically necessitate dynamic adaptations. If the first overlapping basic service set 325 increases its transmission power, the first client device 320 could proactively send an unsolicited beacon report to the access point 310. This report may contain updated basic service set load information, allowing the access point 310 to re-evaluate the current channel assignments. Subsequently, the access point 310 might transmit an initial control frame to seamlessly transition the first client device 320 to a clearer frequency without disrupting the persistent connection of the second client device 330.

In a non-limiting example, the system can leverage the distinct locations of the first client device 320 and the second client device 330 to increase overall bandwidth utilization. While the first client device 320 might be heavily limited by the first overlapping basic service set 325, the second client device 330 could be positioned in a relatively clear area just outside the second overlapping basic service set 335. The access point 310 may determine that the second client device 330 can remain on a reduced bandwidth primary channel for low-latency traffic. Simultaneously, the access point 310 could route the regular traffic of the first client device 320 to a non-primary channel, ensuring that both devices achieve optimal performance within the overlapping basic service set interference environment 300.

Although a specific embodiment for an overlapping basic service set interference environment 300 for carrying out the various steps, processes, methods, and operations described herein is discussed with respect to FIG. 3, any of a variety of systems and/or devices may be utilized in accordance with embodiments of the disclosure. For example, the overlapping basic service set interference environment 300 might contain additional access points or a larger multitude of client devices experiencing diverse radio frequency challenges. Furthermore, the specific dimensions and layouts illustrated could be altered without departing from the core principles of the embodiments described herein. The elements depicted in FIG. 3 may also be interchangeable with other elements of FIGS. 1–2 and 4-13 as required to realize a particularly desired embodiment.

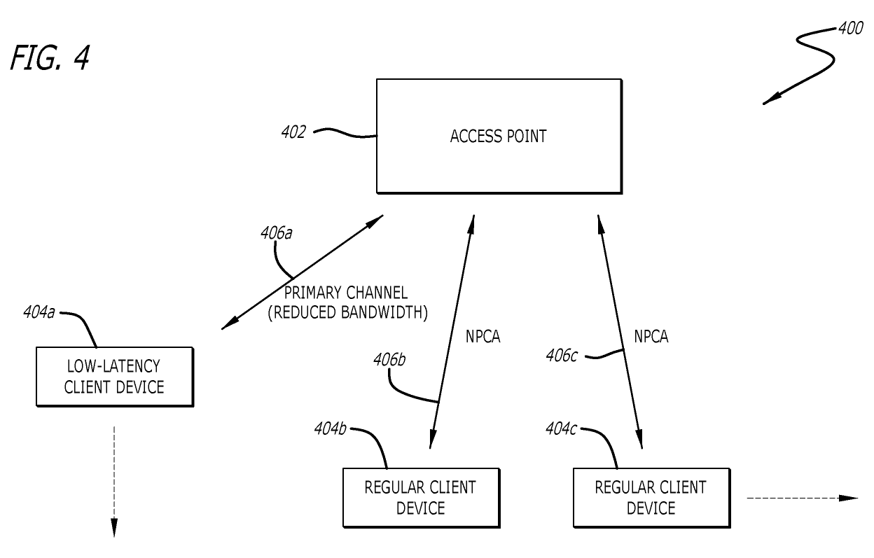

Referring to FIG. 4, a block diagram of a multi-channel assignment topology in accordance with various embodiments of the disclosure is shown. In various embodiments, a multi-channel assignment topology 400 can illustrate how a network manages differing traffic requirements simultaneously. The multi-channel assignment topology 400 might represent an internal traffic management strategy utilized to reduce congestion within a single basic service set. By implementing the multi-channel assignment topology 400, a network administrator could progressively increase overall data throughput. Furthermore, the multi-channel assignment topology 400 may allow for the accommodation of devices with appropriate latency constraints without typically necessitating the degradation of standard traffic.

In many embodiments, an access point 402 can function as the central routing hub for the multi-channel assignment topology 400. The access point 402 might possess the capability to simultaneously manage communications across multiple distinct frequencies. To optimize network performance, the access point 402 could evaluate the specific traffic requirements of all connected stations. Based on these evaluations, the access point 402 may issue proactive scheduling instructions to organize traffic flow. Additionally, the access point 402 can utilize dynamic non-primary channel access management logic to determine the most effective routing strategy.

In some embodiments, a low-latency client device 404a can be connected to the access point 402. The low-latency client device 404a might represent a hardware unit executing an application that relies on persistent, rapid data delivery, such as a voice-over-IP phone or a virtual reality headset. Because dropped packets could substantially reduce the user experience, the low-latency client device 404a may need prioritized access to the wireless medium. The network infrastructure could recognize these appropriate timing needs through polling or explicit requests to join a broadcast schedule. Consequently, the low-latency client device 404a might be granted dedicated resources to satisfy its useful transmission requirements.

In certain embodiments, a primary channel 406a can serve as the default communication medium for the network. The primary channel 406a might be configured to operate with a reduced bandwidth to conserve spectrum while still adequately supporting prioritized traffic. By isolating traffic on the primary channel 406a, the access point 402 could ensure that packets for prioritized applications are delivered without delay. The primary channel 406a may remain active and clear of interference due to the proactive detour of other connected devices. Furthermore, the primary channel 406a can provide a reliable link for the low-latency client device 404a to maintain its scheduled operations.

In further embodiments, a first regular client device 404b can operate concurrently within the same network environment. The first regular client device 404b might generate standard network traffic, such as background downloads or general web browsing, which typically does not have appropriate timing constraints. While it may consume additional bandwidth, the first regular client device 404b could be capable of tolerating minor delays or channel switches. To alleviate congestion, the first regular client device 404b may receive an instruction to vacate the default operating frequency. The first regular client device 404b might then rely on its internal hardware capabilities to execute a transition to an alternative frequency.

regular client device 404b. The first assigned non-primary channel 406b might be specifically In additional embodiments, a first assigned non-primary channel 406b can provide an alternative communication pathway for the first selected based on the localized interference profile measured by that particular device. By utilizing the first assigned non-primary channel 406b, regular data transmissions can proceed without causing collisions on the default frequency. The first assigned non-primary channel 406b may handle a substantial portion of the overall network load, freeing up resources elsewhere. Furthermore, the first assigned non-primary channel 406b could be utilized temporarily or persistently depending on the duration of the scheduled prioritized traffic.

In numerous embodiments, a second regular client device 404c can also be actively communicating with the network infrastructure. The second regular client device 404c might possess different hardware specifications or experience a different physical interference environment compared to other connected stations. Like the other standard devices, the second regular client device 404c could be instructed to move its traffic to avoid causing congestion. The second regular client device 404c may participate in a feedback loop to help the network determine its optimal detour route. By complying with these routing instructions, the second regular client device 404c might contribute to an overall increase in network efficiency.

In various embodiments, a second assigned non-primary channel 406c can be established for the second regular client device 404c. The second assigned non-primary channel 406c might operate on a different frequency than both the default medium and the alternative pathway used by other devices. This distinct routing may be typically necessitated if localized interference makes other frequencies unsuitable for the second regular client device 404c. The second assigned non-primary channel 406c could securely carry the data payload for this specific device while the prioritized traffic continues unabated elsewhere. Consequently, the second assigned non-primary channel 406c can act as a customized detour that fully utilizes the available spectrum.

For example, the components of the multi-channel assignment topology 400 can interact to facilitate same basic service set low latency scheduling. The access point 402 might identify a stream of useful low-latency traffic destined for the low-latency client device 404a. To reduce potential delays, the access point 402 could schedule the low-latency client device 404a on the primary channel 406a operating at a reduced bandwidth. Simultaneously, the access point 402 may instruct the first regular client device 404b and the second regular client device 404c to move their respective traffic. This coordinated action might clear the primary frequency, ensuring the low-latency client device 404a experiences persistent connectivity.

For instance, the system might dynamically adapt the routing strategy based on real-time environmental feedback. The first regular client device 404b could report that certain frequencies are heavily congested due to a neighboring network, while the second regular client device 404c might report a clear frequency in its specific physical location. The access point 402 may process this individualized data to assign the first assigned non-primary channel 406b to the first device and the second assigned non-primary channel 406c to the second device. By routing the standard traffic across these divergent pathways, the access point 402 could progressively increase the overall data throughput. This per-station optimization may substantially reduce the likelihood of collisions, even while the primary channel 406a remains reserved for prioritized communications.

In a non-limiting example, the multi-channel assignment topology 400 can be leveraged to handle unexpected spikes in standard network usage without disrupting established services. If the first regular client device 404b initiates a massive file download, it might consume a vast amount of airtime. To reduce the impact on the low-latency client device 404a, the access point 402 could proactively transition the heavy download traffic to the first assigned non-primary channel 406b. The primary channel 406a may remain undisturbed, allowing the low-latency client device 404a to maintain its appropriate operational timing. Ultimately, the access point 402 might seamlessly return all devices to a unified frequency once the heavy download is fully completed.

Although a specific embodiment for a multi-channel assignment topology 400 for carrying out the various steps, processes, methods, and operations described herein is discussed with respect to FIG. 4, any of a variety of systems and/or devices may be utilized in accordance with embodiments of the disclosure. For example, the multi-channel assignment topology 400 might incorporate additional access points, a larger multitude of client devices, or utilize different wireless routing protocols. The multi-channel assignment topology 400 could also be dynamically reconfigured as network conditions evolve over time. The elements depicted in FIG. 4 may also be interchangeable with other elements of FIGS. 1–3 and 5-13 as required to realize a particularly desired embodiment.

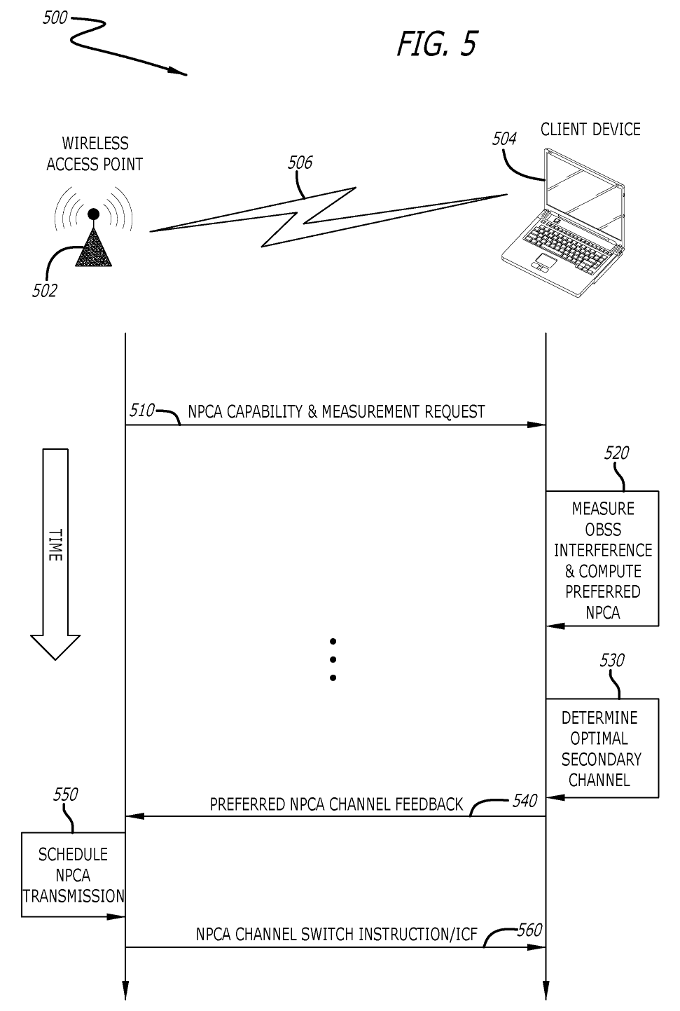

Referring to FIG. 5, a sequence diagram of non-primary channel access feedback and scheduling in accordance with various embodiments of the disclosure is shown. In various embodiments, a sequence diagram 500 can illustrate the chronologically ordered interactions between a network coordinator and a connected node. The sequence diagram 500 might represent the specific data exchanges typically necessitating participation from both devices to facilitate proactive traffic management. By analyzing the sequence diagram 500, network engineers could understand the precise timing of measurement and scheduling events. Consequently, the sequence diagram 500 may provide a blueprint for implementing the dynamic channel assignment features of the embodiments described herein.

In many embodiments, a wireless access point 502 can serve as the primary routing and scheduling entity within the network. The wireless access point 502 might manage the overall spectrum utilization by analyzing the diverse requirements of all associated devices. To reduce congestion, the wireless access point 502 could initiate a structured polling process to gather localized environmental data. Furthermore, the wireless access point 502 may leverage this gathered intelligence to proactively detour traffic away from congested frequencies.

In some embodiments, a client device 504 can represent a mobile or stationary endpoint connected to the network infrastructure. The client device 504 might possess specific hardware capabilities and experience localized interference that differs from other devices on the network. To assist in network optimization, the client device 504 could execute internal processing to evaluate its current operating conditions. Additionally, the client device 504 may be configured to format and transmit these evaluations back to the infrastructure to receive a customized channel assignment.

In certain embodiments, a wireless link 506 can establish the physical communication pathway between the infrastructure and the endpoint. The wireless link 506 might be susceptible to various forms of interference, typically necessitating robust monitoring protocols to maintain appropriate data rates. To ensure persistent connectivity, the network could continually evaluate the quality of the wireless link 506. Moreover, the wireless link 506 may initially operate on a primary channel before being dynamically transitioned to an alternative frequency based on the subsequent scheduled operations.

In further embodiments, an NPCA capability and measurement request 510 can be transmitted to initiate the feedback loop. The NPCA capability and measurement request 510 might prompt the receiving device to assess its current physical environment and hardware limitations. By sending the NPCA capability and measurement request 510, the infrastructure could proactively gather the intelligence typically necessitated for assigning personalized detours. Furthermore, the NPCA capability and measurement request 510 may be sent periodically or dynamically in response to anticipated traffic spikes.

In additional embodiments, a measure OBSS interference and compute preferred NPCA 520 operation can be executed by the receiving endpoint. The measure OBSS interference and compute preferred NPCA 520 process might involve scanning neighboring frequencies to identify overlapping network activity. After quantifying the external interference, the measure OBSS interference and compute preferred NPCA 520 operation could evaluate internal device constraints, such as channel switching delays. Ultimately, the measure OBSS interference and compute preferred NPCA 520 process may synthesize this data to isolate the most viable secondary channel options.

In numerous embodiments, a determine optimal secondary channel 530 process can further refine the generated channel options. The determine optimal secondary channel 530 step might weigh the measured interference against the current battery life and traffic demands of the specific device. By executing the determine optimal secondary channel 530 procedure, the endpoint could identify a single best detour pathway that would substantially reduce potential packet loss. Additionally, the determine optimal secondary channel 530 operation may format this conclusion into a standardized data element for transmission.

In various embodiments, a preferred NPCA channel feedback 540 message can be transmitted back to the network coordinator. The preferred NPCA channel feedback 540 transmission might contain the explicitly computed recommendation generated during the preceding steps. Upon receiving the preferred NPCA channel feedback 540 message, the infrastructure could update its internal routing tables to reflect the specific needs of that endpoint. The preferred NPCA channel feedback 540 transmission may therefore serve as the foundational data point for executing customized, per-station channel assignments.

In some embodiments, a schedule NPCA transmission 550 operation can be performed by the network infrastructure. The schedule NPCA transmission 550 process might analyze the received recommendations alongside the broader network traffic demands and known future transmissions. To progressively increase overall throughput, the schedule NPCA transmission 550 step could allocate specific time windows for devices to operate on their customized secondary channels. Furthermore, the schedule NPCA transmission 550 procedure may ensure that these detours do not conflict with other useful traffic traversing the network.

In certain embodiments, an NPCA channel switch instruction/ICF 560 can be broadcast to finalize the detour assignment. The NPCA channel switch instruction/ICF 560 message might dictate the exact timing and frequency parameters for the upcoming transition. By receiving the NPCA channel switch instruction/ICF 560, the endpoint could prepare its radio hardware to shift to the designated secondary channel. Consequently, the NPCA channel switch instruction/ICF 560 may execute the proactive detour, clearing the primary channel while maintaining appropriate service levels for the rerouted device.

For example, the components detailed in the sequence diagram 500 can collaborate to proactively manage a sudden influx of external interference. The wireless access point 502 might detect a neighboring network powering on and could subsequently transmit the NPCA capability and measurement request 510 to the client device 504. In response, the client device 504 may perform the measure OBSS interference and compute preferred NPCA 520 operation to assess the impact of this new interference source. After executing the determine optimal secondary channel 530 process, the client device 504 could send the preferred NPCA channel feedback 540 to secure a clear pathway, allowing the wireless access point 502 to complete the schedule NPCA transmission 550 operation and issue the NPCA channel switch instruction/ICF 560.

For instance, the interactions illustrated within the sequence diagram 500 might adapt to the varying traffic types handled by the wireless link 506. If the client device 504 is streaming a useful low-latency video feed, the measure OBSS interference and compute preferred NPCA 520 process could place a heavy emphasis on finding a detour with minimal delay. The preferred NPCA channel feedback 540 might reflect this priority, instructing the infrastructure to avoid frequencies with highly variable traffic loads. The wireless access point 502 may then execute the schedule NPCA transmission 550 process to allocate a robust secondary channel, and the subsequent NPCA channel switch instruction/ICF 560 could ensure the video stream remains persistent and clear of congestion.

In a non-limiting example, the sequential flow of the sequence diagram 500 can reduce the overhead associated with managing a dense deployment of devices. Instead of blindly moving all devices to a single detour lane, the wireless access point 502 could rely on the preferred NPCA channel feedback 540 from each individual endpoint to distribute the network load. When the client device 504 performs the determine optimal secondary channel 530 operation, it might consider its own unique hardware capabilities, ensuring that older devices are not assigned to frequencies they cannot support. This targeted approach allows the schedule NPCA transmission 550 process to progressively increase the efficiency of the wireless link 506, utilizing the NPCA channel switch instruction/ICF 560 to orchestrate a highly customized, per-device detour strategy across the entire network.

Although a specific embodiment for a sequence diagram 500 for carrying out the various steps, processes, methods, and operations described herein is discussed with respect to FIG. 5, any of a variety of systems and/or devices may be utilized in accordance with embodiments of the disclosure. For example, the sequence diagram 500 might incorporate additional confirmation messages, different polling intervals, or involve multiple access points coordinating the channel switch. The elements depicted in FIG. 5 may also be interchangeable with other elements of FIGS. 1–4 and 6-13 as required to realize a particularly desired embodiment.

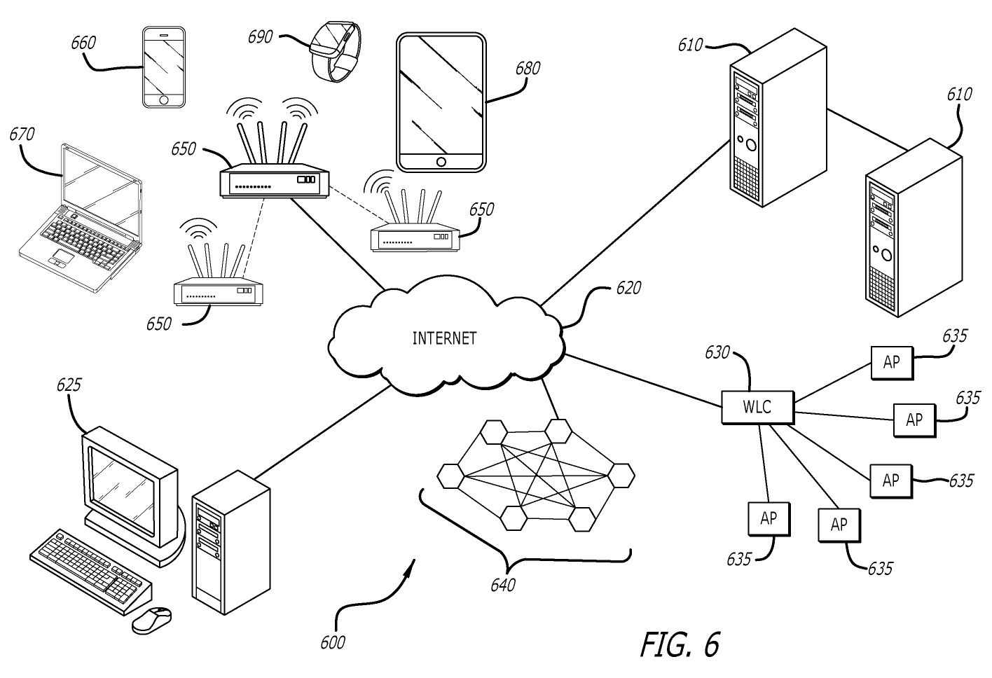

Referring to FIG. 6, a schematic diagram of a deployment environment in accordance with various embodiments of the disclosure is shown. In various embodiments, a deployment environment 600 can illustrate the diverse computing architectures where the dynamic non-primary channel access management logic might be implemented. The deployment environment 600 may encompass a wide variety of hardware configurations, ranging from localized personal networks to expansive enterprise systems. By utilizing the deployment environment 600, network engineers could visualize how the embodiments described herein might be scaled to accommodate different traffic loads and processing capabilities. Consequently, the deployment environment 600 can demonstrate that the proactive scheduling and routing algorithms do not typically necessitate a singular, rigid hardware topology.

In many embodiments, servers 610 can provide robust, remote processing power for the network infrastructure. The servers 610 might be physically located in a remote data center and accessed via wide area network connections. When tasked with computing complex channel assignments for a massive multitude of client devices, the servers 610 could execute the heavy analytical workloads to determine optimal detours. Additionally, the servers 610 may store extensive historical data regarding overlapping basic service set interference to progressively increase the accuracy of future predictive scheduling models. By offloading computations to the servers 610, individual local routers might preserve their own processing resources for persistent packet forwarding.

In some embodiments, an internet 620 can serve as the primary communication backbone linking the various local and remote components. The internet 620 might facilitate the seamless exchange of data packets between mobile endpoints and external application hosts. During out-of-band coordination efforts, the internet 620 could carry restricted target wake time schedules between geographically separated enterprise locations. Furthermore, the internet 620 may provide the necessary pathways for the servers 610 to transmit updated machine-learning models down to local network controllers. Maintaining a reliable connection to the internet 620 can be useful for ensuring that users do not experience service interruptions while traversing a mobility domain.

In certain embodiments, a desktop computer 625 can represent a stationary local machine operating within the network. The desktop computer 625 might act as a localized administration console where a network technician could monitor the current channel assignments. Alternatively, the desktop computer 625 may function as a standard client device that typically necessitates a stable, high-bandwidth connection to perform data-intensive tasks. If the desktop computer 625 generates substantial traffic, the network infrastructure could instruct it to utilize an assigned non-primary channel to clear the default frequency. The desktop computer 625 might then rely on its internal network interface controller to execute the transition and maintain persistent connectivity.

In further embodiments, a wireless LAN controller 630 can be deployed to centralize the management of a localized wireless footprint. The wireless LAN controller 630 might orchestrate the distribution of network policies and routing rules across a building or campus. To reduce overlapping basic service set interference, the wireless LAN controller 630 could process the preferred channel feedback gathered from numerous endpoints. The wireless LAN controller 630 may then synthesize this intelligence to formulate a cohesive, proactive detour strategy for the entire coverage area. Consequently, the wireless LAN controller 630 can issue coordinated channel switch instructions to ensure that local traffic flows smoothly without localized congestion.

In additional embodiments, access points 635 can operate under the direct supervision of the wireless LAN controller 630. The access points 635 might provide the physical radio frequency interfaces that directly connect to the various client devices. Instead of individually determining channel assignments, the access points 635 could forward interference measurements back to the centralized management node. Once a routing decision is made, the access points 635 may receive and broadcast the specific scheduling instructions to their respective connected stations. By acting as subordinate transmitters, the access points 635 might help execute the broader traffic management plan conceived by higher-level logic.

In numerous embodiments, a distributed environment 640 can offer a decentralized approach to executing the non-primary channel access logic. The distributed environment 640 might comprise a mesh of interconnected nodes that share processing responsibilities and network state information. Rather than relying on a single central server, the distributed environment 640 could allow neighboring nodes to collaboratively negotiate channel assignments and coordinate useful transmissions. This shared computational model may substantially reduce the risk of a single point of failure disrupting the wireless coverage. Furthermore, the distributed environment 640 can dynamically scale its processing power by incorporating additional nodes as the physical network expands.

In various embodiments, routers 650 can function as standalone or semi-autonomous network hubs. The routers 650 might be deployed in residential or small office settings where a dedicated enterprise controller is not present. Each of the routers 650 could be equipped with the onboard processing capabilities typically necessitated to independently evaluate local interference and schedule non-primary channel access. To reduce packet collisions, the routers 650 may directly poll their connected devices and compute individualized detours based on the specific hardware limits of those devices. The routers 650 might also communicate with each other over the internet 620 to coordinate schedules when their coverage areas inadvertently overlap.

In some embodiments, a smartphone 660 can act as a highly portable device navigating the wireless spectrum. The smartphone 660 might frequently transition between different coverage zones, exposing it to varying levels of radio frequency congestion. To maintain persistent service during voice or video calls, the smartphone 660 could actively monitor its local environment and calculate a preferred detour frequency. The smartphone 660 may then transmit this customized recommendation to the active infrastructure node. By participating in this proactive feedback loop, the smartphone 660 might ensure it is assigned a secondary channel that fully accommodates its mobility and battery constraints.

In certain embodiments, a laptop 670 can serve as another form of portable device that connects to the deployment environment 600. The laptop 670 might consume additional bandwidth compared to smaller devices when executing complex remote applications or downloading large files. When operating in a crowded area, the laptop 670 could receive an instruction to move its heavy traffic loads to a specific non-primary channel. The laptop 670 may parse this instruction and rapidly switch its radio transceivers to the newly assigned frequency. This targeted routing can help the laptop 670 achieve higher data throughput while simultaneously freeing up the primary channel for other latency-sensitive operations.

In many embodiments, a tablet 680 can also establish a connection within the described networking architectures. The tablet 680 might be utilized for a mix of streaming media and casual web browsing, generating unpredictable bursts of data traffic. To manage these bursts, the network logic could temporarily schedule the tablet 680 on an alternative channel during peak usage times. The tablet 680 may rely on its internal software stack to seamlessly transition between frequencies without causing application errors. Furthermore, the tablet 680 could periodically update its interference measurements to ensure its assigned channel remains optimal as surrounding conditions change.

In further embodiments, a smartwatch 690 can represent a portable device with relatively constrained hardware resources. The smartwatch 690 might have limited battery capacity and slower channel switching speeds, which typically necessitate specialized handling by the network infrastructure. Instead of forcing rapid frequency hops, the network could assign the smartwatch 690 to a stable, persistent secondary channel. The smartwatch 690 may then reliably perform its background synchronization tasks without draining its battery attempting to navigate a congested primary channel. By accommodating these specific constraints, the system might progressively increase the operational lifespan of the smartwatch 690 between charges.

For example, the various components within the deployment environment 600 can collaborate in a highly centralized architecture to manage enterprise traffic. The servers 610 might generate a predictive traffic model and distribute it through the internet 620 to the wireless LAN controller 630. When the smartphone 660 and the laptop 670 enter the coverage area of the access points 635, they could submit their preferred channel feedback directly to the infrastructure. The wireless LAN controller 630 may then cross-reference this feedback with the predictive model provided by the servers 610. Subsequently, the wireless LAN controller 630 could issue precise scheduling commands through the access points 635 to place the smartphone 660 on a primary channel and route the laptop 670 to a non-primary channel, ensuring optimal performance for both portable devices.

For instance, the embodiments described herein might be implemented in a localized, edge computing scenario without relying on external administration. One of the routers 650 could serve as the primary intelligence node for a specific residential building. As the desktop computer 625 begins a large data backup, the routers 650 might detect an impending capacity issue on the default frequency. The routers 650 could poll the tablet 680 and the smartwatch 690 to determine their respective hardware limits and local interference levels. Based on this localized processing, the routers 650 may dynamically transition the tablet 680 and the smartwatch 690 to separate detour channels, successfully reducing congestion without needing to communicate with the servers 610.

In a non-limiting example, the deployment environment 600 can utilize the distributed environment 640 to execute complex channel reassignment logic across a wide physical area. As the smartphone 660 moves through a city, it might encounter overlapping coverage from multiple access points associated with the distributed environment 640. Instead of a single controller making the decision, the nodes within the distributed environment 640 could collaboratively negotiate the best detour pathway based on shared interference data. The distributed environment 640 may then instruct the smartphone 660 to transition frequencies at precise geographic boundaries. This decentralized coordination can substantially reduce latency and ensure that the smartphone 660 maintains persistent connectivity as it traverses the expansive mobility domain.

Although a specific embodiment for a deployment environment 600 for carrying out the various steps, processes, methods, and operations described herein is discussed with respect to FIG. 6, any of a variety of systems and/or devices may be utilized in accordance with embodiments of the disclosure. For example, the deployment environment 600 might encompass additional types of portable devices, different cloud computing architectures, or alternative physical network mediums. The elements depicted in FIG. 6 may also be interchangeable with other elements of FIGS. 1–5 and 7-13 as required to realize a particularly desired embodiment.

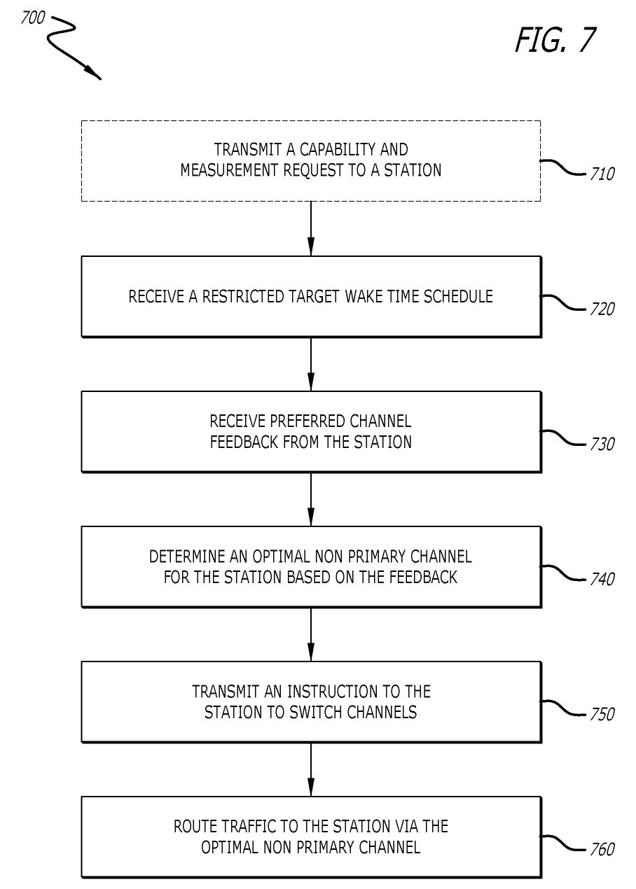

Referring to FIG. 7, a flowchart depicting a process 700 for an access point method in accordance with various embodiments of the disclosure is shown. In various embodiments, the process 700 can represent the logic executed by a network coordinator to manage wireless traffic. The process 700 may allow a system to proactively detour data away from congested frequencies. Furthermore, the process 700 could be utilized to accommodate appropriate timing constraints for specialized client devices without causing collisions.

In many optional embodiments, the process 700 can transmit a capability and measurement request to a station (block 710). The request may be broadcast to multiple stations simultaneously to gather a broad understanding of the local radio frequency environment. For example, an access point might send a formatted management frame querying connected devices for their respective channel switching delays and current battery levels. Alternatively, the communication could be directed as a unicast message to a single, specifically targeted endpoint experiencing poor signal quality. For instance, if a portable device is struggling to maintain a persistent connection, it may receive an individualized prompt to evaluate overlapping network interference.

In further embodiments, the process 700 can receive a restricted target wake time schedule (block 720). The schedule can be delivered from a centralized network controller over an out of band wired backhaul link. In a non-limiting example, a wireless local area network controller could distribute a master timetable outlining useful transmissions that are planned across an entire enterprise deployment. In some arrangements, the timing data might be received wirelessly from a neighboring access point participating in a distributed coordination group. It is contemplated that peer nodes may share their anticipated traffic loads to help nearby hardware avoid scheduling collisions on a primary operating frequency.

In more embodiments, the process 700 can receive preferred channel feedback from the station (block 730). The feedback could be delivered as an unsolicited beacon report generated proactively by the endpoint. For instance, a mobile device might detect a sudden spike in interference and autonomously transmit an updated preferred non primary channel recommendation. In certain embodiments, the data may arrive as a direct response to a previously transmitted polling request from the network infrastructure. For example, the feedback might comprise a structured payload detailing localized congestion levels and specific hardware capabilities, allowing the network to fully understand the operational constraints of the endpoint.

In additional embodiments, the process 700 can determine an optimal non primary channel for the station based on the feedback (block 740). The determination process may utilize a localized algorithm running directly on a routing device to evaluate the available spectrum. In a non-limiting example, a local router could analyze the received recommendations and assign a secondary frequency that avoids localized overlapping basic service set interference. The processing could also be offloaded to a remote machine learning model configured to balance traffic loads across numerous access points. It is contemplated that cloud based servers might synthesize the feedback to progressively increase the efficiency of the entire wireless mobility domain by generating highly customized detours.

In still more embodiments, the process 700 can transmit an instruction to the station to switch channels (block 750). The instruction might be formatted as a dedicated initial control frame utilized to command a frequency transition. For instance, an access point could send a specialized action frame containing explicit timing synchronization parameters to ensure the receiving device moves to the assigned non primary channel without delay. The command could also be embedded within a routine beacon broadcast using a specialized information element. For example, the network infrastructure may append the detour routing details to standard management beacons, reducing the overhead typically necessitating separate unicast messages.

In yet further embodiments, the process 700 can route traffic to the station via the optimal non primary channel (block 760). The data routing may involve forwarding all background data payloads down the newly assigned detour pathway while leaving the default frequency clear. In a non-limiting example, standard internet downloads and software updates could be seamlessly diverted to the optimal non primary channel to ensure that appropriate low latency traffic remains unimpeded on the primary channel. In some embodiments, the routing could dynamically split the traffic, sending certain packet types over the secondary link while maintaining control signaling on the primary connection. It is contemplated that a multi-link operation capable device might simultaneously receive video streams via the optimal non primary channel and basic network updates via a primary frequency, thereby increasing overall throughput.

In additional embodiments, the process 700 can transmit a multi-user enhanced distributed channel access parameter set to coordinate the duration of a frequency detour. The multi-user enhanced distributed channel access parameter set might comprise an active timer that regulates the channel access behavior of connected endpoints. When executing the detour, the transmitted instruction could direct the station to utilize the optimal non primary channel while the active timer is actively running. By utilizing this active timer, the network infrastructure may ensure that the device seamlessly returns to the default operating frequency once the scheduled useful transmission has concluded, thereby progressively increasing overall spectrum efficiency.

In further embodiments, the process 700 can enable more than one non-primary channel for access based on the received data. For example, the network coordinator might analyze the preferred channel feedback to determine if multiple clear frequencies are available. If the preferred channel feedback indicates at least two non-overlapping preferred non-primary channels, the access point could instruct the station to utilize both pathways simultaneously. By enabling more than one non-primary channel for access, the system may progressively increase overall bandwidth for the connected endpoint. This multi-channel assignment could ensure persistent connectivity even if one of the non-overlapping frequencies experiences sudden localized congestion.

Although a specific embodiment for a process 700 for carrying out the various steps, processes, methods, and operations described herein is discussed with respect to FIG. 7, any of a variety of systems and/or processes may be utilized in accordance with embodiments of the disclosure. For example, the process 700 could be adapted to operate over wired local area networks or alternative wireless spectrums to reduce localized congestion. Additionally, the use of optional embodiments does not indicate that the remaining elements are non-optional, but is presented to highlight a separate embodiment and/or to indicate when a decision may be made to not utilize this element. The elements depicted in FIG. 7 may also be interchangeable with other elements of FIGS. 1–6 and 8-13 as required to realize a particularly desired embodiment.

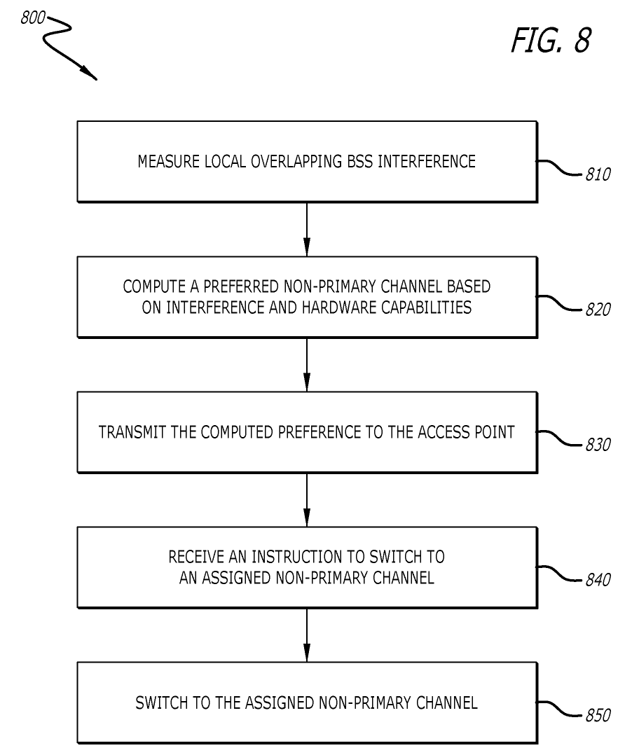

Referring to FIG. 8, a flowchart depicting a process 800 for a station method in accordance with various embodiments of the disclosure is shown. In various embodiments, the process 800 can represent the logic executed by a client device to assist in dynamic non-primary channel access management. The process 800 may allow a mobile endpoint to proactively evaluate its specific radio frequency environment to find a detour route. Furthermore, the process 800 could be utilized to ensure that individual hardware constraints are factored into centralized scheduling decisions to reduce packet loss.

In many embodiments, the process 800 can measure local overlapping BSS interference (block 810). Measuring the interference could involve scanning nearby frequencies to identify transmissions originating from neighboring networks. For example, a laptop may listen for beacon frames broadcast by nearby routers to quantify the localized congestion. In some embodiments, the measurement might encompass analyzing internal signal to noise ratios to determine the overall quality of the primary channel. For instance, a smartphone could persistently evaluate its own packet error rates to deduce the presence of external radio frequency disruptions.

In further embodiments, the process 800 can compute a preferred non-primary channel based on interference and hardware capabilities (block 820). Computing the recommendation could involve synthesizing the previously gathered environmental data with the internal processing limits of the device itself. In a non-limiting example, a smartwatch might prioritize a secondary frequency that typically necessitates the lowest amount of power to transition toward, thereby extending its battery life. In more embodiments, the computation may weigh the specific bandwidth requirements of currently active applications. For instance, a device streaming a live video feed could determine that a wider, albeit slightly more congested, detour channel offers better performance than a narrow, fully clear frequency.

In additional embodiments, the process 800 can transmit the computed preference to the access point (block 830). Transmitting the feedback could utilize an unsolicited management frame sent proactively when conditions deteriorate. For example, a mobile device may generate a customized beacon report to inform the network infrastructure of its localized routing needs. In various embodiments, the transmission might occur as a direct response to a polling request originated by the serving router. It is contemplated that the computed preference may be embedded within standard data payloads to conserve airtime while keeping the network updated on the optimal detour path.

In still more embodiments, the process 800 can receive an instruction to switch to an assigned non-primary channel (block 840). Receiving the command could involve decoding a specialized initial control frame broadcast by the network coordinator. In a non-limiting example, a tablet may parse a targeted management frame that dictates the precise timing and target frequency for an upcoming detour. In certain embodiments, the instruction might be broadcast to multiple devices simultaneously using an updated information element within a routine beacon. By receiving this centralized scheduling command, the device could synchronize its internal clocks to ensure the transition aligns with broader network activities.

In yet further embodiments, the process 800 can switch to the assigned non-primary channel (block 850). Switching channels could encompass reconfiguring the internal radio transceivers to begin listening and transmitting on the new frequency. For example, a laptop may execute the hardware transition to move its regular internet traffic away from a congested primary link. In some embodiments, the transition might be temporary, resulting in a return to the original frequency once a scheduled useful transmission has concluded. For instance, a mobile endpoint could route its traffic through the detour pathway to avoid localized overlapping basic service set interference before resuming standard operations.

Although a specific embodiment for a process 800 for carrying out the various steps, processes, methods, and operations described herein is discussed with respect to FIG. 8, any of a variety of systems and/or processes may be utilized in accordance with embodiments of the disclosure. For example, the process 800 could be adapted to operate over varying wireless standards or incorporate additional confirmation handshakes. Additionally, the use of optional embodiments does not indicate that the remaining elements are non-optional, but is presented to highlight a separate embodiment and/or to indicate when a decision may be made to not utilize this element. The elements depicted in FIG. 8 may also be interchangeable with other elements in FIGS. 1–7 and 9–13 as required to realize a particularly desired embodiment.

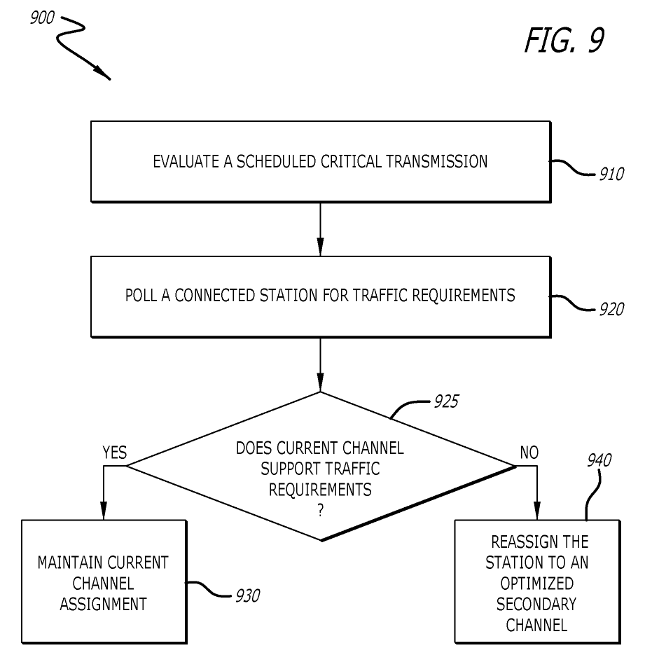

Referring to FIG. 9, a flowchart depicting a process 900 for complex channel reassignment in accordance with various embodiments of the disclosure is shown. In various embodiments, the process 900 can represent the logic executed by a network access point to dynamically adjust frequency allocations. The process 900 may proactively evaluate impending network events to reduce the likelihood of packet collisions across the wireless medium. Furthermore, the process 900 could ensure that devices with varying demands receive appropriate resources without typically necessitating a broad channel switch for all connected stations.

In many embodiments, the process 900 can evaluate a scheduled useful transmission (block 910). Evaluating this transmission might involve analyzing a restricted target wake time schedule received from a neighboring network coordinator. For example, an access point may identify an impending high-priority data transfer that could consume substantial airtime on the primary operating frequency. In some embodiments, the evaluation could also consider internal network events, such as a localized device preparing to execute a voice over internet protocol call. By proactively analyzing these events, the network infrastructure might determine the precise timing and bandwidth typically necessitated to support the upcoming traffic.

In further embodiments, the process 900 can poll a connected station for traffic requirements (block 920). Polling the station could encompass transmitting a management frame that requests the device to report its anticipated data loads. For instance, a local router may query a mobile endpoint to determine if it is merely maintaining a persistent background connection or actively streaming high-definition media. In additional embodiments, the network might request hardware specifications, such as appropriate latency constraints, alongside the raw data transfer needs. Gathering this individualized intelligence may allow the network to formulate a highly targeted routing strategy rather than moving devices unnecessarily.

In more embodiments, the process 900 can determine if a current channel supports traffic requirements (block 925). The determination might weigh the anticipated interference from the scheduled useful transmission against the specific data needs of the polled device. If it is determined that the current channel supports the traffic requirements, then the process 900 can maintain a current channel assignment (block 930). However, if it is determined that the current channel does not support the traffic requirements, then some embodiments of the process 900 can reassign the station to an optimized secondary channel (block 940).

In additional embodiments, the process 900 can maintain a current channel assignment (block 930). Maintaining the assignment could involve leaving the device on the primary operating frequency if its traffic can withstand the impending interference. For example, an endpoint performing background synchronization may not be affected by a brief reduction in available bandwidth. In some embodiments, the network infrastructure might choose to retain the connection to reduce the power consumption associated with executing a frequency transition. This approach may increase overall efficiency by ensuring that specific devices truly needing a detour are relocated.

In yet further embodiments, the process 900 can reassign the station to an optimized secondary channel (block 940). Reassigning the endpoint might entail transmitting a specific initial control frame that commands the radio hardware to transition to a new frequency. In a non-limiting example, a tablet streaming video could be directed to a clear detour channel to ensure its playback remains persistent. In certain embodiments, the selected frequency may be tailored to the specific device based on previously gathered preferred non-primary channel feedback. By executing this targeted relocation, the network could substantially reduce packet loss and maintain appropriate throughput for vulnerable traffic streams.

Although a specific embodiment for a process 900 for carrying out the various steps, processes, methods, and operations described herein is discussed with respect to FIG. 9, any of a variety of systems and/or processes may be utilized in accordance with embodiments of the disclosure. For example, the process 900 could incorporate additional decision blocks to evaluate multiple alternative frequencies simultaneously. Additionally, the use of optional embodiments does not indicate that the remaining elements are non-optional, but is presented to highlight a separate embodiment and/or to indicate when a decision may be made to not utilize this element. The elements depicted in FIG. 9 may also be interchangeable with other elements of FIGS. 1–8 and 10-13 as required to realize a particularly desired embodiment.

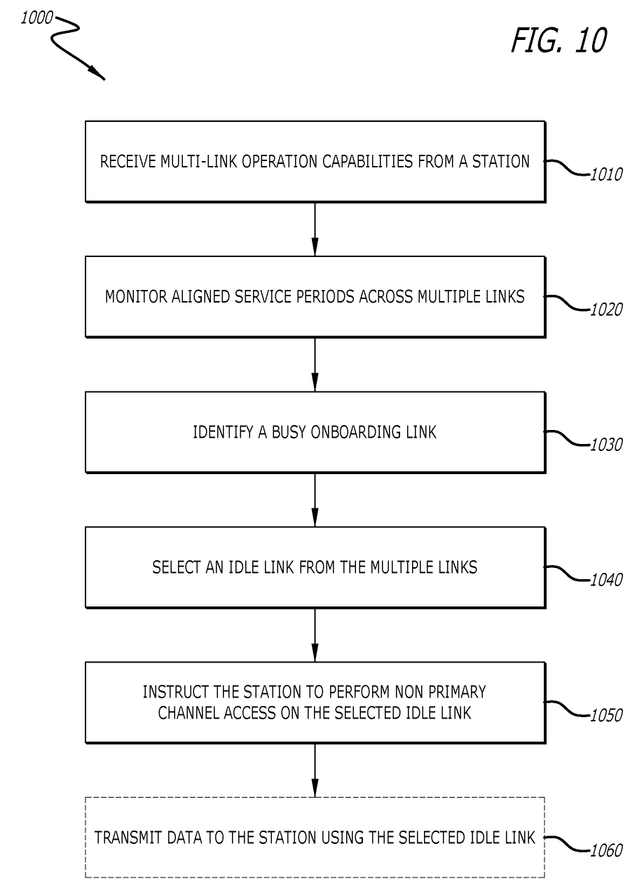

Referring to FIG. 10, a flowchart depicting a process 1000 for multi-link operation cross link non primary channel access in accordance with various embodiments of the disclosure is shown. In various embodiments, the process 1000 can represent the logic executed by a network access point to manage devices capable of maintaining connections across distinct frequencies. The process 1000 may allow a system to seamlessly shift traffic when a specific link becomes congested. Furthermore, the process 1000 could be utilized to progressively increase data throughput without typically necessitating a station to drop its active connection.

In many embodiments, the process 1000 can receive multi-link operation capabilities from a station (block 1010). Receiving the capabilities could involve parsing an initial association request frame transmitted by a new client device joining the network. For example, an access point may identify that a smartphone possesses the hardware to simultaneously transmit and receive on both a two point four gigahertz band and a five gigahertz band. In some embodiments, the process 1000 might query the device directly to determine its supported frequency channels and radio constraints. By gathering this baseline intelligence, the infrastructure can formulate an appropriate routing strategy that leverages all available hardware pathways.

In further embodiments, the process 1000 can monitor aligned service periods across multiple links (block 1020). Monitoring the aligned service periods might encompass evaluating the schedule of upcoming target wake times across the different frequency bands supported by the client device. For instance, a network coordinator could track when a laptop is scheduled to wake up and exchange data on its various established connections. In additional embodiments, the process 1000 may persistently analyze traffic patterns to identify when these active windows overlap or coincide. This synchronization awareness could help the network ensure that instructions are delivered when the receiving hardware is fully awake and ready to process commands.

In more embodiments, the process 1000 can identify a busy onboarding link (block 1030). Identifying the busy onboarding link could involve detecting high levels of overlapping basic service set interference on the specific frequency channel currently being used for management traffic. In a non-limiting example, a router might observe that a neighboring network has initiated a massive file transfer, causing localized congestion on the primary pathway. In certain embodiments, the process 1000 may deduce that the current channel cannot adequately support additional scheduled useful transmissions. Consequently, identifying this bottleneck early might allow the system to prepare a detour before any data packets are actually dropped or delayed.

In additional embodiments, the process 1000 can select an idle link from the multiple links (block 1040). Selecting the idle link might entail evaluating the other established connections maintained by the multi-link capable endpoint. For example, if a five gigahertz connection is congested, the process 1000 could evaluate a secondary six gigahertz connection to see if it currently has available bandwidth. In some embodiments, the selection process may incorporate previously received preferred non primary channel feedback to guarantee the chosen pathway is clear of localized interference. By choosing the most optimal secondary route, the network can seamlessly transition data flows without typically necessitating a full disconnection and reconnection sequence.

In numerous embodiments, the process 1000 can instruct the station to perform non primary channel access on the selected idle link (block 1050). Instructing the station might involve transmitting a targeted management frame that dictates a channel switch to the designated secondary pathway. For instance, an access point could send an initial control frame directing a tablet to move its regular internet traffic to the newly identified clear frequency. In various embodiments, the process 1000 may broadcast this command across the original link before it becomes entirely unusable due to congestion. Upon receiving this instruction, the endpoint could reconfigure its radio transceivers to begin prioritizing the selected detour channel for subsequent communications.

In still more optional embodiments, the process 1000 can optionally transmit data to the station using the selected idle link (block 1060). Transmitting the data could encompass routing all pending and future packets intended for the endpoint down the newly assigned detour frequency. In a non-limiting example, a video stream might be seamlessly redirected to the alternative connection, ensuring persistent playback without buffering. In some embodiments, the process 1000 might utilize the selected link for a temporary duration until the original primary channel clears. This proactive routing strategy may substantially reduce packet collisions while maintaining appropriate service levels for the user.

For example, the components and steps of the process 1000 can collaborate to manage sudden interference spikes in a dense enterprise network. An access point might receive multi-link operation capabilities from a station (block 1010) indicating support for three distinct frequency bands. As the access point continues to monitor aligned service periods across multiple links (block 1020), it could identify a busy onboarding link (block 1030) caused by a nearby rogue router. To reduce service interruption, the access point may select an idle link from the multiple links (block 1040) and instruct the station to perform non primary channel access on the selected idle link (block 1050).

For instance, the process 1000 might dynamically adapt to changing traffic types such as voice over internet protocol calls. If a user initiates an application with appropriate latency constraints, the network coordinator could realize the primary connection is becoming congested and identify a busy onboarding link (block 1030). The system may quickly evaluate the multi-link operation capabilities from a station (block 1010) and select an idle link from the multiple links (block 1040). Subsequently, the network could instruct the station to perform non primary channel access on the selected idle link (block 1050) and then transmit data to the station using the selected idle link (block 1060), ensuring a persistent and clear audio connection.

In a non-limiting example, the process 1000 can be utilized to balance loads across an entire building. A central controller may persistently monitor aligned service periods across multiple links (block 1020) for hundreds of connected devices. When an area experiences a surge in data usage, the system might identify a busy onboarding link (block 1030) for several devices simultaneously. By leveraging the multi-link operation capabilities from a station (block 1010), the controller could intelligently select an idle link from the multiple links (block 1040) uniquely tailored to each device, and individually instruct the station to perform non primary channel access on the selected idle link (block 1050) to progressively increase the overall capacity of the wireless environment.

Although a specific embodiment for a process 1000 for carrying out the various steps, processes, methods, and operations described herein is discussed with respect to FIG. 10, any of a variety of systems and/or processes may be utilized in accordance with embodiments of the disclosure. For example, the process 1000 could be adapted to operate over alternative wireless standards or incorporate additional confirmation handshakes. Additionally, the use of optional embodiments does not indicate that the remaining elements are non-optional, but is presented to highlight a separate embodiment and/or to indicate when a decision may be made to not utilize this element. The elements depicted in FIG. 10 may also be interchangeable with other elements of FIGS. 1–9 and 11–13 as required to realize a particularly desired embodiment.

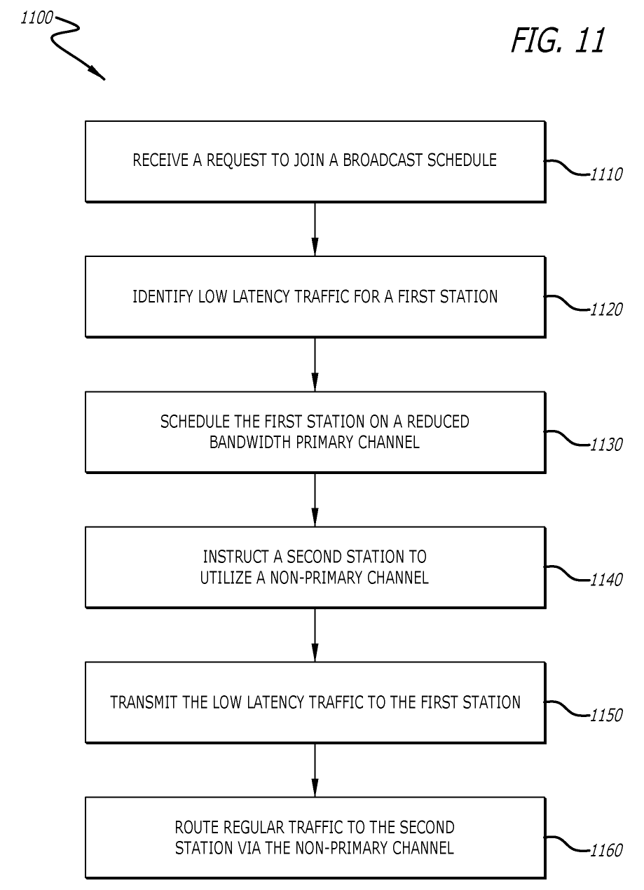

Referring to FIG. 11, a flowchart depicting a process 1100 for a same-BSS low latency scheduling process in accordance with various embodiments of the disclosure is shown. In various embodiments, the process 1100 can represent the logic executed by a network coordinator to manage internal traffic flow. The process 1100 may proactively organize communications to ensure that appropriate timing constraints are met for prioritized applications. Furthermore, the process 1100 could be utilized to progressively increase overall data throughput by separating disparate traffic types onto distinct operating frequencies.

In additional embodiments, the process 1100 can incorporate an intra-basic service set network allocation vector to manage detour timing. For example, the network coordinator may set an intra-basic service set network allocation vector for the second station to logically reserve the primary medium for the low latency traffic. The instruction transmitted to the second station might direct the station to utilize the optimal non primary channel for a specific duration of the intra-basic service set network allocation vector. By linking the detour duration to this specific vector, the network infrastructure could ensure the secondary endpoint remains on the alternative frequency until the prioritized broadcast is concluded.

In many embodiments, the process 1100 can receive a request to join a broadcast schedule (block 1110). Receiving this request might involve parsing a management frame transmitted by a new client device seeking to establish a persistent connection. For example, an access point may identify that a virtual reality headset is attempting to join the network and typically necessitates a dedicated timeslot for data reception. In some embodiments, the request could include specific hardware capabilities indicating the endpoint supports prioritized routing protocols.

In further embodiments, the process 1100 can identify low latency traffic for a first station (block 1120). Identifying this traffic could encompass analyzing the packet headers of incoming data streams to detect specific quality of service markers. For instance, a local router may determine that an incoming video stream is highly sensitive to delay and typically necessitates expedited handling. In additional embodiments, the network infrastructure might persistently monitor active sessions to flag any payload that would suffer from standard queuing delays.

In more embodiments, the process 1100 can schedule the first station on a reduced bandwidth primary channel (block 1130). Scheduling the endpoint might involve allocating specific transmission windows on a dedicated, narrower frequency band to conserve overall spectrum. By utilizing this configuration, the access point could provide a highly reliable pathway that is less susceptible to overlapping basic service set interference. For example, reserving this specialized link may substantially reduce the likelihood of packet collisions for the prioritized data stream.

In additional embodiments, the process 1100 can instruct a second station to utilize a non-primary channel (block 1140). Instructing the secondary endpoint could entail transmitting a targeted initial control frame that commands a detour away from the default operating frequency. For instance, the network coordinator may prompt a device performing background updates to transition its radio hardware to an alternative clear channel. In certain embodiments, this instruction might be generated based on previously received preferred channel feedback to ensure the new assignment is optimal for that specific endpoint.

In numerous embodiments, the process 1100 can transmit the low latency traffic to the first station (block 1150). Transmitting the data might involve forwarding the time-sensitive packets down the previously reserved primary connection. Because the primary medium has been cleared of standard traffic, the access point could deliver the payloads with a reduced delay. For example, an audio call might proceed without interruption, fulfilling the appropriate service requirements established during the initial connection phase.

In still more embodiments, the process 1100 can route regular traffic to the second station via the non-primary channel (block 1160). Routing this standard data could encompass directing web browsing and file downloads through the detour pathway. By separating the regular network load from the prioritized streams, the infrastructure may effectively utilize all available radio frequencies. In a non-limiting example, this concurrent routing strategy might progressively increase the overall capacity of the wireless environment while maintaining the stability of the primary link.

Although a specific embodiment for a process 1100 for carrying out the various steps, processes, methods, and operations described herein is discussed with respect to FIG. 11, any of a variety of systems and/or processes may be utilized in accordance with embodiments of the disclosure. For example, the process 1100 could be adapted to operate with multiple priority levels, scheduling several endpoints across varying bandwidth configurations. Additionally, the use of optional embodiments does not indicate that the remaining elements are non-optional, but is presented to highlight a separate embodiment and/or to indicate when a decision may be made to not utilize this element. The elements depicted in FIG. 11 may also be interchangeable with other elements of FIGS. 1–10 and 12–13 as required to realize a particularly desired embodiment.

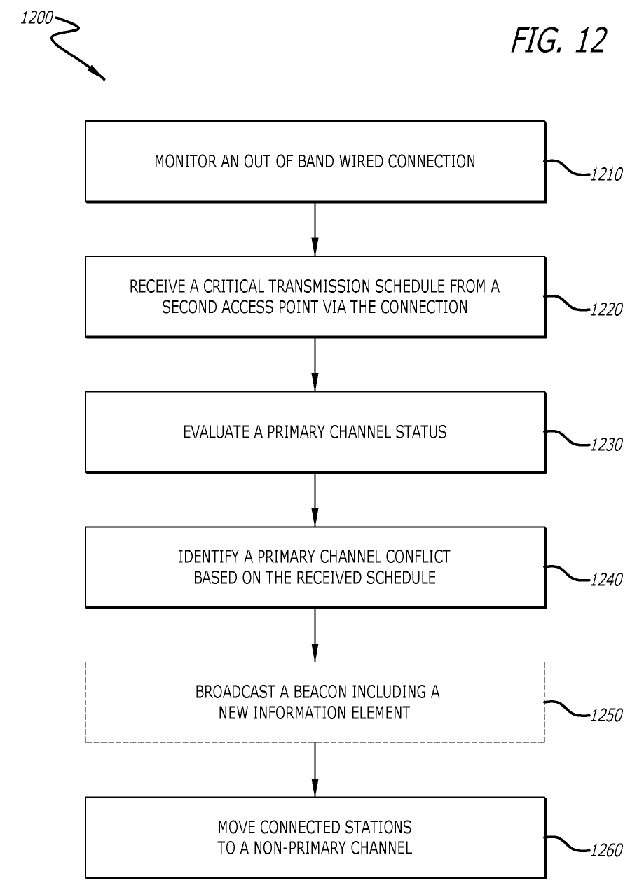

Referring to FIG. 12, a flowchart depicting a process 1200 for an out of band multi-AP coordination process in accordance with various embodiments of the disclosure is shown. In various embodiments, the process 1200 can represent the logic executed by a network access point to coordinate with neighboring infrastructure nodes. The process 1200 may proactively evaluate impending network events communicated over a backhaul link to reduce the likelihood of packet collisions. Furthermore, the process 1200 could ensure that devices receive appropriate resources without typically necessitating localized over the air scheduling exchanges.

In many embodiments, the process 1200 can monitor an out of band wired connection (block 1210). Monitoring this connection might involve persistently listening for data packets arriving via an ethernet backhaul or fiber optic link that connects multiple access points together. For example, a local router may evaluate incoming traffic from a central controller to detect specialized coordination frames. In some embodiments, the network infrastructure could rely on this wired pathway to avoid taking up valuable wireless spectrum with management overhead.

In further embodiments, the process 1200 can receive a useful transmission schedule from a second access point (block 1220). Receiving this schedule could encompass parsing a payload that outlines specific time windows reserved for high priority traffic in an adjacent coverage area. For instance, a neighboring node may communicate that it intends to broadcast appropriate low latency data across a shared frequency within the next few milliseconds. In additional embodiments, the network infrastructure might utilize this advanced warning to proactively adjust its own routing plans.

In more embodiments, the process 1200 can evaluate a primary channel status (block 1230). Evaluating the status might involve analyzing the current and anticipated traffic loads of the default operating frequency. For example, an access point may check its internal queuing buffers to determine how much standard traffic is slated for transmission. In some embodiments, this evaluation could also consider localized interference patterns to deduce if the primary frequency has the capacity to absorb additional congestion without issue.

In additional embodiments, the process 1200 can identify a primary channel conflict based on the received schedule (block 1240). Identifying this conflict might entail discovering that the local access point and the neighboring node are both planning to utilize the same frequency at the exact same time. For instance, the local router may realize that its planned standard data broadcasts will overlap with the anticipated useful transmissions of the adjacent device. In certain embodiments, identifying this bottleneck early could allow the system to prepare a detour before any data packets are delayed or dropped.

In still more optional embodiments, the process 1200 can broadcast a beacon including a new information element (block 1250). Broadcasting this specialized beacon could involve embedding specific routing instructions within the routine management frames transmitted by the access point. For example, the network coordinator may append an information element that flags the impending conflict and advertises an available secondary frequency. In various embodiments, utilizing a beacon to distribute this instruction might ensure that all connected devices are notified concurrently, which could reduce the overhead typically necessitating separate unicast messages to each individual station.

In yet further embodiments, the process 1200 can move connected stations to a non-primary channel (block 1260). Moving the stations might entail executing a coordinated frequency transition for a plurality of active devices to clear the default pathway. For instance, a group of laptops performing standard web browsing could be directed to a detour frequency to avoid the scheduled useful transmission from the neighboring node. In some embodiments, the selected detour could be uniquely tailored to each station based on previously gathered preferred channel feedback to progressively increase overall capacity.

For example, the components and steps of the process 1200 can collaborate to seamlessly manage interference between overlapping enterprise networks. A first network router might monitor an out of band wired connection (block 1210) to communicate with a second nearby router. As traffic patterns fluctuate, the first router may receive a useful transmission schedule from a second access point via the connection (block 1220). Upon receiving this data, the first router could evaluate a primary channel status (block 1230) to see if it plans to broadcast during the reserved window. If it discovers overlapping plans, it may identify a primary channel conflict based on the received schedule (block 1240). To mitigate the issue, the first router might broadcast a beacon including a new information element (block 1250) to alert its devices, and ultimately move connected stations to a non-primary channel (block 1260) to keep the primary link clear.

For instance, the process 1200 might dynamically adapt to changing traffic priorities without disrupting existing services. If a neighboring device prepares for an appropriate voice over internet protocol call, the local access point could monitor an out of band wired connection (block 1210) to catch the impending setup. The local access point may then receive a useful transmission schedule from a second access point via the connection (block 1220) and evaluate a primary channel status (block 1230) to determine its own load. Realizing that its standard background traffic would cause interference, the local access point might identify a primary channel conflict based on the received schedule (block 1240). The system could then bypass individual messages, elect to broadcast a beacon including a new information element (block 1250), and move connected stations to a non-primary channel (block 1260) to ensure the voice call is not delayed.

In a non-limiting example, the process 1200 can be utilized to balance loads across an entire building utilizing predictive logic. A centralized controller may direct multiple nodes to monitor an out of band wired connection (block 1210) to share their anticipated data needs. One node might receive a useful transmission schedule from a second access point via the connection (block 1220) detailing a massive impending download. The receiving node could evaluate a primary channel status (block 1230) and identify a primary channel conflict based on the received schedule (block 1240) before the download even begins. Subsequently, the receiving node may broadcast a beacon including a new information element (block 1250) to proactively move connected stations to a non-primary channel (block 1260), successfully navigating the impending congestion and progressively increasing data throughput.

Although a specific embodiment for a process 1200 for carrying out the various steps, processes, methods, and operations described herein is discussed with respect to FIG. 12, any of a variety of systems and/or processes may be utilized in accordance with embodiments of the disclosure. For example, the process 1200 could be adapted to operate with multiple priority levels, scheduling several endpoints across varying bandwidth configurations. Additionally, the use of optional embodiments does not indicate that the remaining elements are non-optional, but is presented to highlight a separate embodiment and/or to indicate when a decision may be made to not utilize this element. The elements depicted in FIG. 12 may also be interchangeable with other elements of FIGS. 1–11 and 13 as required to realize a particularly desired embodiment.

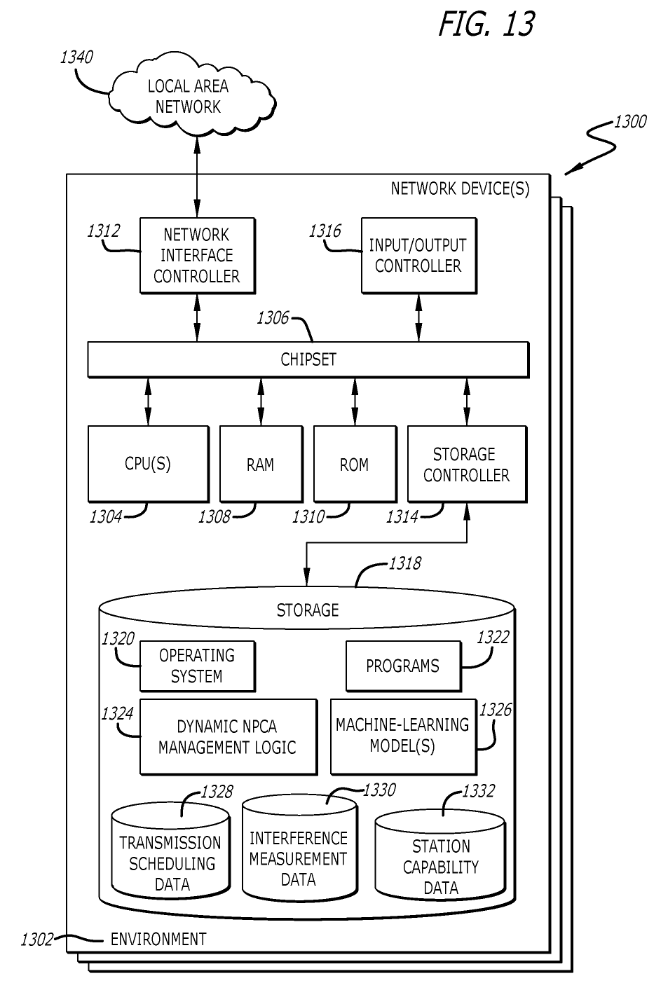

Referring to FIG. 13, a conceptual block diagram of a device 1300 suitable for configuration with a dynamic NPCA management logic 1324 for implementing the functionality and various embodiments of the disclosure is shown. The embodiment of the device 1300 in the conceptual block diagram depicted in FIG. 13 may relate to a conventional server computer, a workstation, a desktop computer, a laptop, a tablet, a network appliance, an electronic reader, a smartphone, or other computing device, and can be utilized to execute any of the application and/or logic components presented herein. The device 1300 may, in some examples, correspond to a physical device or to a virtual resource described herein. The device 1300 can be a network device, for example, an access point, a router, a switch, any type of edge-based network device, a server, a system, or the like in accordance with various embodiments of the disclosure.

In many embodiments, the device 1300 may include an environment 1302, which may represent the overall operational context or physical assembly, such as a baseboard or a motherboard, in physical embodiments that can be configured as a printed circuit board with a multitude of components or devices connected by way of a system bus or other electrical communication paths. Conceptually, in virtualized embodiments, the environment 1302 may be a virtual environment that encompasses and executes the remaining components and resources of the device 1300. In a number of embodiments, CPU(s) 1304 such as, but not limited to, Central Processing Units, can be configured to operate in conjunction with a chipset 1306. The CPU(s) 1304 can be standard programmable CPUs that perform arithmetic and logical operations that may support the operation of the device 1300. In a variety of embodiments, the CPU(s) 1304 can perform one or more operations by transitioning from one discrete, physical state to the next through the manipulation of switching elements that differentiate between and change these states. Switching elements generally can include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, or the like.

In various embodiments, the chipset 1306 may provide an interface between the CPU(s) 1304 and the remainder of the components and devices within the device 1300. The chipset 1306 can provide an interface to a Random-Access Memory (RAM 1308), which can be utilized as the main memory in the device 1300 in some embodiments. The chipset 1306 can further be configured to provide an interface to a computer-readable storage medium such as a Read-Only Memory (ROM 1310) or a Non-Volatile RAM (NVRAM) for storing basic routines that can help with various tasks such as, but not limited to, starting up the device 1300 and/or transferring information between the various components and devices. The ROM 1310 or NVRAM can also store other application components that may support the operation of the device 1300 in accordance with various embodiments described herein. Different embodiments of the device 1300 can be configured to operate in a networked environment using logical connections to remote computing devices and computer systems through a network, such as the local area network 1340. The chipset 1306 can include functionality for providing network connectivity through a network interface controller 1312, which may include a gigabit Ethernet adapter, a high-speed SerDes interface, or similar component. The network interface controller 1312 can be capable of connecting the device 1300 to other devices over the local area network 1340. It is contemplated that a network interface controller 1312, or multiple, may be present in the device 1300, connecting the device 1300 to other types of networks and remote systems.

The device 1300 may also include other device(s) connected to the input/output controller 1316 or system bus. In more embodiments, the device 1300 can be connected to a storage 1318 that provides non-volatile storage for data accessible by the device 1300. The storage 1318 can, for example, store an operating system 1320, programs 1322, transmission scheduling data 1328, interference measurement data 1330, and station capability data 1332, which are described in greater detail below. The storage 1318 can be connected to the main system components through a storage controller 1314 connected to the chipset 1306 or system bus. In additional embodiments, the storage 1318 can include one or more physical storage units. The storage controller 1314 can interface with the physical storage units through interfaces such as a Serial Advanced Technology Attachment interface, a Fiber Channel interface, a Serial Attached SCSI interface, where SCSI refers to a Small Computer System Interface, or other type of interface for physically connecting and transferring data between computers and physical storage units. The device 1300 can store data within the storage 1318 by transforming the physical state of the physical storage units to reflect the information being stored. The specific transformation of the physical state can depend on various factors. Examples of such factors can include, but are not limited to, the technology utilized to implement the physical storage units, whether the storage 1318 is characterized as primary or secondary storage, and the like. For example, the device 1300 can store information within the storage 1318 by issuing instructions through the storage controller 1314 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided to facilitate this description. The device 1300 can further read or access information from the storage 1318 by detecting the physical states or characteristics of one or more particular locations within the physical storage units.

In addition to the storage 1318 described above, the device 1300 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1300. In some examples, the operations performed by a cloud computing network, and or any components included therein, may be supported by one or more devices similar to the device 1300. Stated otherwise, some or all of the operations performed by a cloud computing network, and or any components included therein, may be performed by the device 1300 operating in a cloud-based arrangement. By way of example, and not limitation, computer-readable storage media can include volatile, non-volatile, removable, and non-removable media implemented in any method or technology. Computer-readable storage media includes, but is not limited to, RAM, ROM, Erasable Programmable ROM, Electrically-Erasable Programmable ROM, flash memory or other solid-state memory technology, Compact Disc-ROM, Digital Versatile Disk, High Definition DVD, BLU-RAY, or other optical storage, magnetic cassettes, magnetic tape, magnetic disk storage or other magnetic storage devices, or any other medium that can be utilized to store the desired information in a non-transitory fashion.

As mentioned briefly above, the storage 1318 can store an operating system 1320 utilized to control the operation of the device 1300. According to one embodiment, the operating system 1320 includes the LINUX operating system. According to another embodiment, the operating system 1320 includes the Windows server operating system from Microsoft Corporation. According to further embodiments, the operating system 1320 can include the UNIX operating system or one of its variants. It should be appreciated that other operating systems can also be utilized. The storage 1318 can store other system or application programs and data utilized by the device 1300. In still more embodiments, the storage 1318 or other computer-readable storage media is encoded with computer-executable instructions which, when loaded into the device 1300, may transform the device 1300 from a general-purpose computing system into a special-purpose computer capable of implementing the embodiments described herein. These computer-executable instructions may be stored as programs 1322 and transform the device 1300 by specifying how the CPU(s) 1304 can transition between states, as described above. In still further embodiments, the device 1300 has access to computer-readable storage media storing computer-executable instructions which, when executed by the device 1300, perform the various processes described with regard to the flowcharts of the present disclosure. In still additional embodiments, the device 1300 can also include computer-readable storage media having instructions stored thereupon for performing any of the other computer-implemented operations described herein. In some more embodiments, the device 1300 can also include one or more input/output controller 1316 for receiving and processing input from a number of input devices, such as a keyboard, a mouse, a touchpad, a touch screen, an electronic stylus, or other type of input device. Similarly, an input/output controller 1316 can be configured to provide output to a display, such as a computer monitor, a flat panel display, a digital projector, a printer, or other type of output device. Those skilled in the art will recognize that the device 1300 may not include all of the components shown in FIG. 13, and can include other components that are not explicitly shown in FIG. 13, or may utilize an architecture different. As described above, the device 1300 may support a virtualization layer, such as one or more virtual resources executing on the device 1300. In some examples, the virtualization layer may be supported by a hypervisor that provides one or more virtual machines running on the device 1300 to perform functions described herein. The virtualization layer may generally support a virtual resource that performs at least a portion of the techniques described herein.

The dynamic NPCA management logic 1324, in various embodiments, may represent a dedicated hardware circuit, a programmable logic device, a set of instructions executed by CPU(s) 1304, or a combination thereof, within the device 1300. This dynamic NPCA management logic 1324 can be configured to manage and regulate various channel assignments within the wireless system, particularly those that may be useful for the operation of sensitive low-latency applications that might be managed by the network interface controller 1312 or other device(s) within device 1300. It is contemplated that dynamic NPCA management logic 1324 can implement processes for generating proactive detour assignments, buffering incoming scheduling data, and applying predictive coordination to produce a stable wireless environment, as described in various embodiments of the disclosure. In certain embodiments, the dynamic NPCA management logic 1324 can actively monitor inputs such as transmission scheduling data 1328, interference measurement data 1330, and station capability data 1332 to make informed routing adjustments. For example, if interference measurement data 1330 indicates noise on a primary channel, or if transmission scheduling data 1328 signals that a bandwidth-intensive application is initializing, the dynamic NPCA management logic 1324 might adjust the channel assignments to substantially reduce packet loss. Similarly, based on station capability data 1332, the dynamic NPCA management logic 1324 could implement device-specific compensation techniques to maintain the stability of connections, ensuring consistent performance across varying interference conditions within the wireless domain. The operations of dynamic NPCA management logic 1324 may facilitate providing a clear secondary channel to a connected station, which can then be utilized to seamlessly offload standard traffic.

The machine-learning model(s) 1326, in some embodiments, may represent a computational engine or a set of algorithms configured to learn from data and make predictions or decisions without being explicitly programmed for every specific scenario. This machine-learning model(s) 1326 can be executed by the CPU(s) 1304 or specialized hardware within device 1300 and may interact closely with the dynamic NPCA management logic 1324. It is contemplated that the machine-learning model(s) 1326 could be trained using transmission scheduling data 1328 that is historical or simulated, interference measurement data 1330, station capability data 1332, and potentially other system performance metrics to identify complex patterns and correlations relevant to spectrum stability and traffic management. In certain embodiments, the machine-learning model(s) 1326 can analyze incoming real-time data and provide predictive insights or optimized control parameters to the dynamic NPCA management logic 1324. For example, it might predict impending overlapping basic service set disturbances based on current routing activity and historical interference patterns, allowing the dynamic NPCA management logic 1324 to take proactive routing measures. Furthermore, the machine-learning model(s) 1326 could learn optimal settings for non-primary channel detour generation under various operating conditions to enhance throughput, potentially adapting these settings over time as the network layout ages or environmental radio frequency conditions change. This approach, leveraging machine-learning model(s) 1326, can enable more adaptive, and potentially more efficient operation of the dynamic NPCA management logic 1324 compared to traditional control methods.

The transmission scheduling data 1328, in various embodiments, may encompass a range of timing parameters and load measurements collected from different points within the deployment environment. This data could include, for example, real-time records of various restricted target wake time schedules, the measured output of current basic service set loads, or the anticipated durations of high-priority traffic streams that may be generated by connected devices. Transmission scheduling data 1328 might also include information about overlapping broadcast windows, multi-link operation service periods, or upcoming out-of-band management events, which can be relevant in environments with dynamically switching client endpoints managed by the network interface controller 1312. In certain embodiments, the dynamic NPCA management logic 1324 can utilize transmission scheduling data 1328 as an input for its decision-making processes associated with spectrum regulation and proactive detouring. By analyzing transmission scheduling data 1328, the dynamic NPCA management logic 1324 can assess the stability and capacity of various default and secondary frequencies within the system. If, for example, transmission scheduling data 1328 reveals that a specific channel is scheduled to become heavily congested, this information can trigger corrective actions by the dynamic NPCA management logic 1324, such as generating an initial control frame to adjust a device connection to an alternative frequency to maintain appropriate network throughput.

The interference measurement data 1330, in many embodiments, may represent information pertaining to the localized radio frequency congestion levels or signal-to-noise ratios detected by different components, modules, or client stations within the environment. This data can include, but is not limited to, the overlapping basic service set profiles reported by individual devices indicating whether a channel is clear, occupied, or experiencing high error rates. Interference measurement data 1330 might also reflect current environmental scans compiled by surrounding access points, the operational metrics of neighboring unmanaged networks, or flags indicating specific external signal disruptions. It is contemplated that the dynamic NPCA management logic 1324 can process interference measurement data 1330 to anticipate or respond to changes in environmental conditions that could affect link stability or bandwidth availability. For example, if interference measurement data 1330 indicates that multiple rogue routers are broadcasting simultaneously nearby, the dynamic NPCA management logic 1324 might proactively adjust the detour algorithms to better handle the expected packet loss and reduce transmission retries. Conversely, if interference measurement data 1330 shows that a previously congested frequency is now clear, the logic might adapt routing assignments to transition devices back to the default channel to conserve spectrum, while ensuring that the primary connection remains stable for any devices that are still active. The use of interference measurement data 1330 can thus enable context-aware and efficient bandwidth management by the dynamic NPCA management logic 1324.

The station capability data 1332, in some embodiments, may consist of hardware profiles and related operational constraints gathered from one or more client devices connected within the wireless network. These profiles might monitor the available radio transceivers within a specific endpoint, the supported multi-link operation features of specific integrated circuits, or even localized battery power states reported by the connected station. Station capability data 1332 can provide the dynamic NPCA management logic 1324 with insights into the device limitations and how they might be changing due to varying application loads or mobility conditions. It is contemplated that the dynamic NPCA management logic 1324 can utilize station capability data 1332 to implement tailored detour schemes or per-station optimization strategies. Since the performance characteristics of mobile devices can vary wildly, leading to differences in parameters like channel switching delays or multi-band support, the dynamic NPCA management logic 1324 can use station capability data 1332 to make corrective adjustments to its routing plans. For example, it might adjust target wake time intervals or tune the selection of a secondary channel based on readings from station capability data 1332 to counteract known hardware sensitivities of legacy endpoints, thereby helping to maintain stable connections across a wider range of device types, and this adjustment of an assignment may further utilize such hardware constraint data. This can contribute to the overall robustness and reliability of the operations orchestrated by the device 1300.

Although a specific embodiment for a device 1300 suitable for configuration with the dynamic NPCA management logic 1324 for carrying out the various steps, processes, methods, and operations described herein is discussed with respect to FIG. 13, any of a variety of systems and/or processes may be utilized in accordance with embodiments of the disclosure. For example, the dynamic NPCA management logic 1324 could interface with additional types of sensor data beyond those explicitly shown, or the machine-learning model(s) 1326 could be implemented using a distributed architecture across multiple processing elements within device 1300. The elements depicted in FIG. 13 may also be interchangeable with other elements of FIGS. 1–12 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous,” “exemplary,” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A network device, comprising:
a processor;
at least one network interface controller configured to provide access to a network; and
a memory communicatively coupled to the processor, wherein the memory comprises a dynamic NPCA management logic that is configured to:
receive a restricted target wake time schedule;
receive a preferred channel feedback from a station;
determine an optimal non-primary channel for the station;
transmit an instruction to the station; and
route traffic to the station via the optimal non-primary channel.

2. The network device of claim 1, wherein the optimal non-primary channel for the station is based on the preferred channel feedback.

3. The network device of claim 2, wherein the instruction to the station is to switch channels.

4. The network device of claim 1, wherein the preferred channel feedback is based on a level of interference measured from an overlapping basic service set (OBSS) and hardware capabilities of the station.

5. The network device of claim 1, wherein the preferred channel feedback is received within an unsolicited beacon report, and wherein the unsolicited beacon report includes basic service set load information.

6. The network device of claim 1, wherein the restricted target wake time schedule indicates a scheduled critical transmission by a second network device in an overlapping basic service set.

7. The network device of claim 1, wherein the instruction to the station is transmitted via an information element within a beacon frame or via an initial control frame.

8. The network device of claim 1, wherein the dynamic NPCA management logic is further configured to poll the station to determine a traffic requirement and a power requirement wherein determining the optimal non-primary channel is further based on the traffic requirement and a proximity of the station to the network device derived from the power requirement.

9. The network device of claim 1, wherein the dynamic NPCA management logic is further configured to schedule low-latency traffic for a second station on a primary channel using a reduced bandwidth, wherein routing the traffic to the station via the optimal non-primary channel preserves the primary channel for the low-latency traffic.

10. The network device of claim 1, wherein the dynamic NPCA management logic is further configured to:
monitor a plurality of links associated with a multi-link operation capabilities of the station; and
identify a busy onboarding link, wherein the optimal non-primary channel is assigned on a selected idle link from the plurality of links.

11. A network device, comprising:
a processor;
at least one network interface controller configured to provide access to a network; and
a memory communicatively coupled to the processor, wherein the memory comprises a dynamic NPCA management logic that is configured to:
measure local overlapping basic service set interference;
compute a preferred non-primary channel based on at least the measured interference;
transmit the computed preference to an access point;
receive an instruction to switch to an assigned non-primary channel; and
switch to the assigned non-primary channel.

12. The network device of claim 11, wherein the preferred non-primary channel is computed based on at least the measured interference and one or more hardware capabilities.

13. The network device of claim 11, wherein transmitting the computed preference to the access point comprises transmitting an unsolicited beacon report, wherein the unsolicited beacon report includes basic service set load information associated with the local overlapping basic service set interference.

14. The network device of claim 11, wherein the computed preference is transmitted to the access point via an information element within an action frame, and wherein the dynamic NPCA management logic is configured to transmit the information element periodically or dynamically in response to a change in the measured interference.

15. The network device of claim 11, wherein the dynamic NPCA management logic is further configured to: detect that an onboarding link of a multi-link operation is busy; and utilize an idle link of the multi-link operation to request the assigned non-primary channel from the access point.

16. A method of non-primary channel access, comprising:
receiving a restricted target wake time schedule;
receiving a preferred channel feedback from a station;
determining an optimal non-primary channel for the station;
transmitting an instruction to the station; and
routing traffic to the station via the optimal non-primary channel.

17. The method of claim 16, wherein the restricted target wake time schedule is received from a second network device operating in a same extended service set via an out-of-band communication link.

18. The method of claim 16, further comprising enabling more than one non-primary channel for access if the preferred channel feedback indicates at least two non-overlapping preferred non-primary channels.

19. The method of claim 16, further comprising setting an intra-basic service set network allocation vector for a second station, wherein the instruction directs the station to utilize the optimal non-primary channel for a duration of the intra-basic service set network allocation vector.

20. The method of claim 16, further comprising transmitting a multi-user enhanced distributed channel access parameter set comprising an active timer, wherein the instruction directs the station to utilize the optimal non-primary channel while the active timer is running.
